(19) United States
(12) Patent Application Publication
(10) Pub. No.: US 2010/0047624 A1
(43) Pub. Date: Feb. 25, 2010

(54) ELECTROCONDUCTIVE FILM, ELECTROCONDUCTIVE POLYMER COMPOSITION, ELECTROCONDUCTIVE POLYMER MATERIAL AND DEVICE

(75) Inventors: Katsuyuki YOFU, Kanagawa (JP); Takashi KATO, Kanagawa (JP); Naoyuki HAYASHI, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/540,388

(22) Filed: Aug. 13, 2009

(30) Foreign Application Priority Data
Aug. 20, 2008 (JP) 2008-211985

(51) Int. Cl. H01B 1/12; B32B 9/00

(52) U.S. Cl. 428/704; 252/500

(57) ABSTRACT

The electroconductive film of the present invention contains an electroconductive polymer and a compound represented by the following Formula (1). In Formula (1), Y is a hydrogen atom, a carbon atom, a hetero atom, a hydroxy group, a mercapto group, a group derived from an amino group, a group derived from an alkyl group, a group derived from an acyl group, a group derived from an aryl group, a group derived from an alkoxy group, a group derived from an aryloxy group, or a group derived from a heteroaryl group. L is a single bond, a divalent hydrocarbon group, a divalent hetero atom or an imino group. m is an integer of 1 or more.

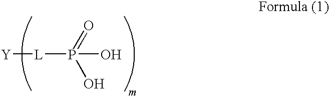

### CROSS REFERENCE TO RELATED APPLICATIONS

This application claims priority under 35USC 119 from Japanese Patent Application No. 2008-211985, filed on Aug. 20, 2008, the disclosure of which is incorporated herein by reference.

### BACKGROUND OF THE INVENTION

1. Field of the Invention

The present invention relates to an electroconductive film, an electroconductive polymer composition, an electroconductive polymer material and a device.

2. Description of the Related Art

In recent years, transparent electroconductive films using a metallic material, such as ITO-based electroconductive films, have been broadly used in various fields in image display units (displays) typified by liquid crystal displays (LCDs), plasma display panels (PDPs) and electroluminescence (EL) devices or the like, and furthermore in touch panels typified by ATMs (automated teller machines), ticket machines at stations, game machines for domestic use and various types of mobile instruments, and are undergoing remarkable development.

Generally, electroconductive films using a metallic material, such as ITO-based electroconductive films, are produced by forming, on a glass substrate, a film from a metallic material by a vapor phase method such as a vacuum deposition method or a sputtering method. Display devices such as portable telephones and mobile instruments have been becoming lighter in weight, and it has been demanded that a display device substrate be shifted from glass to plastic. The introduction of a plastic substrate has reduced the weight of display devices to become half or less in comparison to the convectional products, and a plastic substrate has been remarkably improved in strength and impact resistance.

There, however, is a problem with regard to ITO-based electroconductive films in that the substitution of glass substrates with plastic films results in a decrease in adhesiveness, and making a substrate and a formed electroconductive film prone to easily peel apart from each other, whereby in cases where ITO-based electroconductive films are applied to touch panels, electroconductivity is gradually lowered due to physical force of pushing with a finger or pen. Moreover, metallic materials, such as ITO, are ordinarily formed into a film by using a vapor phase method such as sputtering, so that an expensive production apparatus needs to be used.

An electroconductive polymer is known as a conductive material that can replace metallic materials such as ITO. The use of an electroconductive polymer allows a conductive thin film to be formed by coating and offers the advantage that a conductive thin film may be inexpensively produced. Moreover, an electrode made of an electroconductive polymer is more flexible and less brittle than ITO electrodes, and it therefore is less prone to break even though it is used for flexible items. Accordingly, it is advantageous to apply an electrode made of an electroconductive polymer to touch panels that specifically require high flexibility, since lifetime may be extended in view of durability and reliability of apparatuses.

As such an electroconductive polymer, polythiophene containing polyanion has been developed, and a technique for forming an electroconductive film by using this polymer is disclosed in the specification of European Patent No. 440957. It, however, has become clear that this electroconductive film is slightly weaker in durability under humidity and heat than ITO films and the like and that it may not achieve a durability sufficient for practical use in some applications.

In particular, when the electroconductive film is applied to display devices, durability under humidity and heat, that is, no reduction in transparency or conductivity even under an environment with certain degrees of heat and humidity or greater, is very important.

On the other hand, Japanese Patent Application Laid-Open (JP-A) No. 2006-131873 reports that durability under humidity and heat is improved by adding an aromatic compound having two or more hydroxy groups to polythiophene. Furthermore, JP-A No. 2007-95506 reports that stability under humidity and heat is improved by adding a polymer so as to increase film density.

### SUMMARY OF THE INVENTION

A first aspect of the present invention is an electroconductive film containing an electroconductive polymer and a compound represented by the following Formula (1):

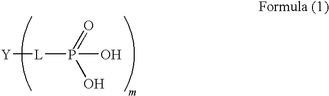

In Formula (1), Y is a hydrogen atom, a carbon atom, a hetero atom, a hydroxy group, a mercapto group, a group derived from an amino group, a group derived from an alkyl group, a group derived from an acyl group, a group derived from an aryl group, a group derived from an alkoxy group, a group derived from an aryloxy group, or a group derived from a heteroaryl group. L is a single bond, a divalent hydrocarbon group, a divalent hetero atom or an imino group. m is an integer of 1 or more.

A second aspect of the present invention is an electroconductive polymer composition containing an electroconductive polymer or a precursor thereof and a compound represented by the following Formula (1):

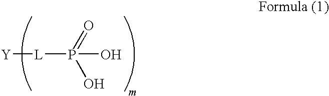

In Formula (1), Y is a hydrogen atom, a carbon atom, a hetero atom, a hydroxy group, a mercapto group, a group derived from an amino group, a group derived from an alkyl group, a group derived from an acyl group, a group derived from an aryl group, a group derived from an alkoxy group, a group derived from an aryloxy group, or a group derived from a heteroaryl group. L is a single bond, a divalent hydrocarbon group, a divalent hetero atom or an imino group. m is an integer of 1 or more.

A third aspect of the present invention is an electroconductive polymer material containing

a substrate, and

an electroconductive polymer layer containing an electroconductive polymer and a compound represented by the following Formula (1):

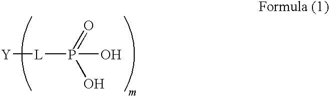

In Formula (1), Y is a hydrogen atom, a carbon atom, a hetero atom, a hydroxy group, a mercapto group, a group derived from an amino group, a group derived from an alkyl group, a group derived from an acyl group, a group derived from an aryl group, a group derived from an alkoxy group, a group derived from an aryloxy group, or a group derived from a heteroaryl group. L is a single bond, a divalent hydrocarbon group, a divalent hetero atom or an imino group. m is an integer of 1 or more.

A fourth aspect of the present invention is an electroconductive polymer material containing

a layer containing an electroconductive polymer, and

a layer containing a compound represented by the following Formula (1), which is formed on at least one surface of the layer containing an electroconductive polymer:

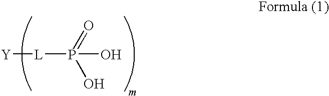

In Formula (1), Y is a hydrogen atom, a carbon atom, a hetero atom, a hydroxy group, a mercapto group, a group derived from an amino group, a group derived from an alkyl group, a group derived from an acyl group, a group derived from an aryl group, a group derived from an alkoxy group, a group derived from an aryloxy group, or a group derived from a heteroaryl group. L is a single bond, a divalent hydrocarbon group, a divalent hetero atom or an imino group. m is an integer of 1 or more.

A fifth aspect of the present invention is a device using the electroconductive film according to the first aspect.

A sixth aspect of the present invention is a device using the electroconductive polymer material according to the third or fourth aspect.

### BRIEF DESCRIPTION OF THE DRAWINGS

FIG. 1 is a cross-sectional schematic view showing the constitutional example of the electroconductive film of the present invention.

FIG. 2 is a cross-sectional schematic view showing other constitutional example of the electroconductive film of the present invention.

FIG. 3 is a cross-sectional schematic view showing other constitutional example of the electroconductive film of the present invention.

FIG. 4 is a cross-sectional schematic view showing an example of the layer constitution of the electroconductive polymer material of the first exemplary embodiment of the present invention.

FIG. 5 is a cross-sectional schematic view showing an example of the layer constitution of the electroconductive polymer material of the second exemplary embodiment of the present invention.

FIG. 6 is a cross-sectional schematic view showing another example of the layer constitution of the electroconductive polymer material of the second exemplary embodiment of the present invention.

FIG. 7 is a cross-sectional schematic view showing another example of the layer constitution of the electroconductive polymer material of the second exemplary embodiment of the present invention.

### DETAILED DESCRIPTION OF THE INVENTION

Hereinafter, the present invention will be described in detail. The denotation “to” in this specification means the numerals before and after “to”, both inclusive as the minimum value and the maximum value, respectively.

It has been found that durability under humidity and heat is certainly improved but transparency or electroconductivity is decreased by the techniques described in JP-A Nos. 2006-131873 and 2007-95506 mentioned above.

In consideration of the above-mentioned circumstance, the inventors have conducted intensive studies and found that an electroconductive film containing an electroconductive polymer and a compound represented by the following Formula (1) is excellent in transparency and electroconductivity, as well as heat durability. Based on this finding, the inventors have conducted further studies and completed the present invention. Particularly, it has also been found that localization of the compound represented by Formula (1) on the surface of the layer containing an electroconductive polymer by spraying, coating or the like is preferable for improving the durability under humidity and heat of the electroconductive film.

In the present invention, “durability under humidity and heat” refers to variation in the transmittance and surface resistance after a certain period has passed under the conditions of temperature of 60° C. and humidity of 90% RH, and the smaller the variation in the transmittance and surface resistance becomes, the more excellent the durability under humidity and heat becomes.

<Electroconductive Film>

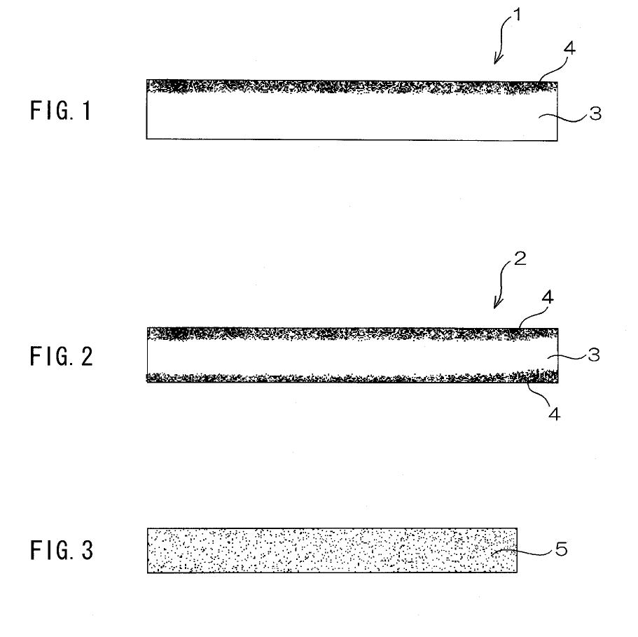

The electroconductive film of the present invention contains an electroconductive polymer and a compound represented by Formula (1). First, the constitutional examples of the specific electroconductive films are shown in FIGS. 1 to 3.

In the electroconductive films 1 and 2 in FIGS. 1 and 2, the compound 4 represented by Formula (1) is localized on the surface of the film 3 containing an electroconductive polymer.

The electroconductive film 5 of FIG. 3 is a film containing an electroconductive polymer and a compound represented by Formula (1).

In the electroconductive film 1 shown in FIG. 1, the compound 4 represented by Formula (1) is localized on the boundary surface (specifically on the boundary surface contacting with air) of the film 3 containing an electroconductive polymer, and the film 3 containing an electroconductive polymer is protected by the compound represented by Formula (1). This is particularly preferable in view of durability under heat and humidity since the durability under humidity and heat of the electroconductive film 1 is further improved.

In a more preferable aspect wherein the compound 4 represented by Formula (1) is localized on the surface of the film 3 containing an electroconductive polymer, the compound 4 represented by Formula (1) is localized on both surfaces of the film 3 containing an electroconductive polymer.

Furthermore, in the electroconductive films 1 and 2 shown in FIGS. 1 and 2, the content of the compound represented by Formula (1) may be decreased in, or not added to, the parts other than the surfaces of the film 3 containing an electroconductive polymer, whereby durability under humidity and heat may be improved without significantly changing the properties such as film forming property and electroconductivity of the film 3 containing an electroconductive polymer. Accordingly, the degree of freedom of the combination of the electroconductive polymer or a precursor thereof and the compound of Formula (1) may be expanded.

As the method for the production of the electroconductive films 1 and 2 in FIGS. 1 and 2, the following method including forming the film 3 containing an electroconductive polymer may be used, that is, a method for forming the film 3 includes an applying process that a liquid containing the compound represented by Formula (1) is applied such as spraying on the surface of the film 3 while the film 3 is dried, and further a drying process that the film is dried. Alternatively, as another method, a method including preparing the film 3 containing an electroconductive polymer and soaking the film 3 in a liquid containing the compound represented by Formula (1) may be used.

Whether or not the compound represented by Formula (1) is localized on the surface of the electroconductive film may be confirmed by using TOF-SIMS apparatus (trade name, manufactured by ION-TOF) and XPS apparatus (trade name: QUANTERA SXM, manufactured by PHI).

The electroconductive film 5 represented by FIG. 3 contains the electroconductive polymer and the compound represented by Formula (1). Such electroconductive film 5 may be formed from the electroconductive polymer composition mentioned below. Namely, since the electroconductive film 5 represented by FIG. 3 is obtained by first preparing the electroconductive polymer composition and forming the composition into a film by a method such as coating, it may be prepared by a convenient method.

The film thickness of the electroconductive film of the present invention is preferably in the range of from 1 nm to 2 μm, and more preferably in the range of from 10 nm to 1 μm. In case where the film thickness of the electroconductive film is in this range, sufficient electroconductivity and transparency may be achieved.

In view of convenience that an electroconductive film having a large area may be prepared at a time, it is preferable that the film 3 containing an electroconductive polymer or the electroconductive film 5 is formed by coating. Examples of the methods other than coating may include spin coating, transferring and the like. The coating liquid may be an aqueous dispersion or an organic solvent. Specifics of the coating liquid are explained for the electroconductive polymer material mentioned below.

Hereinafter the compound included in the electroconductive film of the present invention is explained.

(1) Electro-Conductive Polymer

The electroconductive polymer to be used for the present invention refers to a polymer which exhibits an electrical conductivity of 10⁻⁶ S·cm⁻¹ or more. Any polymer corresponding to the above may be used. More preferred is a polymer having an electrical conductivity of 10⁻¹ S·cm⁻¹ or more.

The electroconductive polymer is preferably a non-conjugated polymer or conjugated polymer made up of aromatic carbon rings or aromatic heterocycles linked by single bonds or divalent or multivalent linking groups.

The aromatic carbon rings in the non-conjugated polymer or conjugated polymer is, for example, a benzene ring and also may be formed a fused ring.

The aromatic heterocycle in the non-conjugated polymer or conjugated polymer is, for example, a pyridine ring, a pyrazine ring, a pyrimidine ring, a pyridazine ring, a triazine ring, an oxazole ring, a thiazole ring, an imidazole ring, an oxadiazole ring, a thiadiazole ring, a triazole ring, a tetrazole ring, a furan ring, a thiophene ring, a pyrrole ring, an indole ring, a carbazole ring, a benzimidazole ring, an imidazopyridine ring, or the like. It also may be formed a fused ring and may have a substituent.

Examples of the divalent or multivalent linking group in a non-conjugated polymer or conjugated polymer include linking groups formed by a carbon atom, a silicon atom, a nitrogen atom, a boron atom, an oxygen atom, a sulfur atom, metal, metal ion, or the like. Preferred are a carbon atom, a nitrogen atom, a silicon atom, a boron atom, an oxygen atom, a sulfur atom, and a group formed of a combination thereof. Examples of such a group formed of a combination include a methylene group, a carbonyl group, an imino group, a sulfonyl group, a sulfinyl group, an ester group, an amide group and a silyl group, which are either substituted or unsubstituted.

Specific examples of the electroconductive polymer include polyaniline, poly(para-phenylene), poly(para-phenylenevinylene), polythiophene, polyfuran, polypyrrole, polyselenophene, polyisothianaphthene, polyphenylene sulfide, polyacethylene, polypyridylvinylene and polyazine, which are electroconductive and are either substituted or non-substituted. These may be used either singly or, according to the purpose, in combination of two or more kinds thereof.

If a desired electrical conductivity is achieved, it may be used in the form of a mixture with another polymer having no electrical conductivity, and copolymers of such monomers with other monomers having no electrical conductivity may also be used.

The electroconductive polymer is preferably a conjugated polymer. Examples of such a conjugated polymer include polyacethylene, polydiacetylene, poly(para-phenylene), polyfluorene, polyazulene, poly(para-phenylene sulfide), polypyrrole, polythiophene, polyisothianaphthene, polyaniline, poly(para-phenylenevinylene), poly(2,5-thienylenevinylene), multiple chain type conjugated polymers (polyperinaphthalene, an the like), metal phthalocyanine-type polymers, and other conjugated polymers [poly(para-xylylene), poly[α-(5,5′-bithiophenediyl)benzylidene], and the like.

Preferred are poly(para-phenylene), polypyrrole, polythiophene, polyaniline, poly(para-phenylenevinylene) and poly(2,5-thienylenevinylene). More preferred are poly(para-phenylene), polythiophene and poly(para-phenylenevinylene).

Such conjugated polymers may have a substituent, examples of the substituent include substituents which are described as R¹¹ in Formula (I) given below.

In the present invention, it is preferable, from the viewpoint of compatibility of high transparency and high electrical conductivity, particularly that the electroconductive polymers have a partial structure represented by the following Formula (I) (in other words, that it be polythiophene or its derivative).

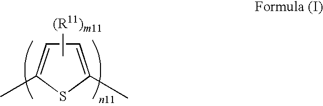

In Formula (I), R¹¹ represents a substituent; and m11 is an integer of from 0 to 2. When m11 represents 2, the R¹¹s may be either the same or different and also may be linked each other to form a ring. n¹¹ is an integer of 1 or greater.

The substituent represented by R¹¹ includes alkyl groups (preferably having 1 to 20 carbon atoms, more preferably having 1 to 12 carbon atoms, and still more preferably having 1 to 8 carbon atoms; for example, methyl, ethyl, isopropyl, tert-butyl, n-octyl, n-decyl, n-hexadecyl, cyclopropyl, cyclopentyl and, cyclohexyl), alkenyl groups (preferably having 2 to 20 carbon atoms, more preferably having 2 to 12 carbon atoms, and still more preferably having 2 to 8 carbon atoms; for example, vinyl, allyl, 2-butenyl, 3-pentenyl, 2-hexenyl, 3-hexenyl, 4-hexenyl and 2-octenyl), alkynyl groups (preferably having 2 to 20 carbon atoms, more preferably having 2 to 12 carbon atoms, and still more preferably having 2 to 8 carbon atoms; for example, propargyl and 3-pentynyl), aryl groups (preferably having 6 to 30 carbon atoms, more preferably having 6 to 20 carbon atoms, and still more preferably having 6 to 12 carbon atoms; for example, phenyl, p-methylphenyl and naphthyl), amino group (preferably having 0 to 20 carbon atoms, more preferably having 0 to 10 carbon atoms, and still more preferably having 0 to 6 carbon atoms; for example, amino, methylamino, dimethylamino, diethylamino, dibenzylamino, and diphenylamino),

alkoxy groups (preferably having 1 to 20 carbon atoms, more preferably having 1 to 12 carbon atoms, and still more preferably having 1 to 8 carbon atoms; for example, methoxy, ethoxy, butoxy, hexyloxy and octyloxy), aryloxy groups (preferably having 6 to 20 carbon atoms, more preferably having 6 to 16 carbon atoms, and still more preferably having 6 to 12 carbon atoms; for example, phenyloxy and 2-naphthyloxy), acyl groups (preferably having 1 to 20 carbon atoms, more preferably having 1 to 16 carbon atoms, and still more preferably having 1 to 12 carbon atoms; for example, acetyl, benzoyl, formyl and pivaloyl), alkoxycarbonyl groups (preferably having 2 to 20 carbon atoms, more preferably having 2 to 16 carbon atoms, and still more preferably having 2 to 12 carbon atoms; for example, methoxycarbonyl and ethoxycarbonyl), aryloxycarbonyl groups (preferably having 7 to 20 carbon atoms, more preferably having 7 to 16 carbon atoms, and still more preferably having 7 to 10 carbon atoms; for example, phenyloxycarbonyl),

acyloxy group (preferably having 2 to 20 carbon atoms, more preferably having 2 to 16 carbon atoms, and still more preferably having 2 to 10 carbon atoms; for example, acetoxy and benzoyloxy), acylamino groups (preferably having 2 to 20 carbon atoms, more preferably having 2 to 16 carbon atoms, and still more preferably having 2 to 10 carbon atoms; for example, acetylamino and benzoylamino), alkoxycarbonylamino groups (preferably having 2 to 20 carbon atoms, more preferably having 2 to 16 carbon atoms, and still more preferably having 2 to 12 carbon atoms; for example, methoxycarbonylamino), aryloxycarbonylamino groups (preferably having 7 to 20 carbon atoms, more preferably having 7 to 16 carbon atoms, and still more preferably having 7 to 12 carbon atoms; for example, phenyloxycarbonylamino), sulfonylamino groups (preferably having 1 to 20 carbon atoms, more preferably having 1 to 16 carbon atoms, and still more preferably having 1 to 12 carbon atoms; for example, methanesulfonylamino and benzenesulfonylamino), a sulfamoyl group (preferably having 0 to 20 carbon atoms, more preferably having 0 to 16 carbon atoms, and still more preferably having 0 to 12 carbon atoms; for example, sulfamoyl, methylsulfamoyl, dimethylsulfamoyl and phenylsulfamoyl),

carbamoyl groups (preferably having 1 to 20 carbon atoms, more preferably having 1 to 16 carbon atoms, and still more preferably having 1 to 12 carbon atoms; for example, carbamoyl, methylcarbamoyl, diethylcarbamoyl and phenylcarbamoyl), alkylthio groups (preferably having 1 to 20 carbon atoms, more preferably having 1 to 16 carbon atoms, and still more preferably having 1 to 12 carbon atoms; for example, methylthio and ethylthio), arylthio groups (preferably having 6 to 20 carbon atoms, more preferably having 6 to 16 carbon atoms, and still more preferably having 6 to 12 carbon atoms; for example, phenylthio), sulfonyl groups (preferably having 1 to 20 carbon atoms, more preferably having 1 to 16 carbon atoms, and still more preferably having 1 to 12 carbon atoms; for example, mesyl and tosyl), sulfinyl groups (preferably having 1 to 20 carbon atoms, more preferably having 1 to 16 carbon atoms, and still more preferably having 1 to 12 carbon atoms; for example, methanesulfinyl and benzenesulfinyl), ureido groups (preferably having 1 to 20 carbon atoms, more preferably having 1 to 16 carbon atoms, and still more preferably having 1 to 12 carbon atoms; for example, ureido, methylureido and phenylureido), phosphoamide groups (preferably having 1 to 20 carbon atoms, more preferably having 1 to 16 carbon atoms, and still more preferably having 1 to 12 carbon atoms; for example, diethyl phosphoamide and phenyl phosphoamide),

a hydroxy group, a mercapto group, halogen atoms (for example, fluorine atom, chlorine atom, bromine atom and iodine atom), a cyano group, a sulfo group, a carboxyl group, a nitro group, a hydroxamic acid group, a sulfino group, a hydrazino group, an imino group, heterocyclic groups (preferably having 1 to 20 carbon atoms and more preferably having 1 to 12 carbon atoms; examples of hetero atoms include a nitrogen atom, an oxygen atom and a sulfur atom; specific examples include pyrrolidine, piperidine, piperazine, morpholine, thiophene, furan, pyrrole, imidazole, pyrazole, pyridine, pyrazine, pyridazine, triazole, triazine, indole, indazole, purine, thiazoline, thiazole, thiadiazole, oxazoline, oxazole, oxadiazole, quinoline, isoquinoline, phthalazine, naphthylydine, quinoxaline, quinazoline, cinnoline, pteridine, acridine, phenanthroline, phenazine, tetrazole, benzimidazole, benzoxazole, benzthiazole, benzotriazole and tetraazaindene), and silyl groups (preferably having 3 to 40 carbon atoms, more preferably having 3 to 30 carbon atoms, and still more preferably having 3 to 24 carbon atoms; for example, trimethylsilyl and triphenylsilyl).

The substituent represented by R¹¹ may be additionally substituted. When it has a plural substituents, they may be either the same or different and may, if possible, be linked together to form a ring. Examples of the ring to be formed include a cycloalkyl ring, a benzene ring, a thiophene ring, a dioxane ring and a dithiane ring.

The substituent represented by R¹¹ is preferably an alkyl group, an alkenyl group, an alkynyl group, an alkoxy group and an alkylthio group, and more preferably an alkyl group, an alkoxy group and an alkylthio group. In still more preferably, when m11 is 2, two R¹¹s are alkoxy groups or alkylthio groups forming a ring, and it is preferable to form a dioxane ring or a dithiane ring.

When m11 is 1 in Formula (I), R¹¹ is preferably an alkyl group, and more preferably an alkyl group having 2 to 8 carbon atoms.

When Formula (I) is poly(3-alkylthiophene) that R¹¹ is an alkyl group, the linkage mode between the adjacent thiophene rings includes a sterically regular mode in which all thiophene rings are linked by 2-5′ and a sterically irregular mode which contains 2-2′ linkages and 5-5′ linkages. Among them, the sterically irregular mode is preferred.

In the present invention, it is particularly preferable, from the viewpoint of achieving both high transparency and high electrical conductivity, that the electroconductive polymer is 3,4-ethylenedioxy-polythiophene, which is specific example compound (6) shown below.

The polythiophene represented by Formula (I) and derivatives thereof may be prepared by known methods such as those disclosed in J. Mater. Chem., 15, 2077-2088 (2005) and Advanced Materials, 12(7), 481 (2000). For examples, Denatron P502 (manufactured by NAGASE CHEMICAL CO., LTD.), 3,4-ethylenedioxythiophene (BAYTRON (registered trademark) M V2), and 3,4-polyethylenedioxythiopene/polystyrenesulfonate (BAYTRON (registered trademark) P), BAYTRON (registered trademark) C), BAYTRON (registered trademark) F E, BAYTRON (registered trademark) M V2, BAYTRON (registered trademark) P, BAYTRON (registered trademark) P AG, BAYTRON (registered trademark) P HC V4, BAYTRON (registered trademark) P HS, BAYTRON (registered trademark) PH, BAYTRON (registered trademark) PH 500 and BAYTRON (registered trademark) PH 510 (all the BAYTRONs are manufactured by H.C. Starck GmbH) may be obtained as commercial products.

A polyaniline (manufactured by Aldrich Chemical Company, Inc.), a polyaniline (ereraldine (phonetic) base) (manufactured by Aldrich Chemical Company, Inc.), or the like are available as polyaniline or derivatives thereof

A polypyrrole (manufactured by Aldrich Chemical Company, Inc.) or the like are available as polypyrrole or derivatives thereof

Specific examples of an electroconductive polymer are shown below, but the present invention is not limited to them. Besides these, compounds disclosed in W098/01909 and so on are also provided as examples.

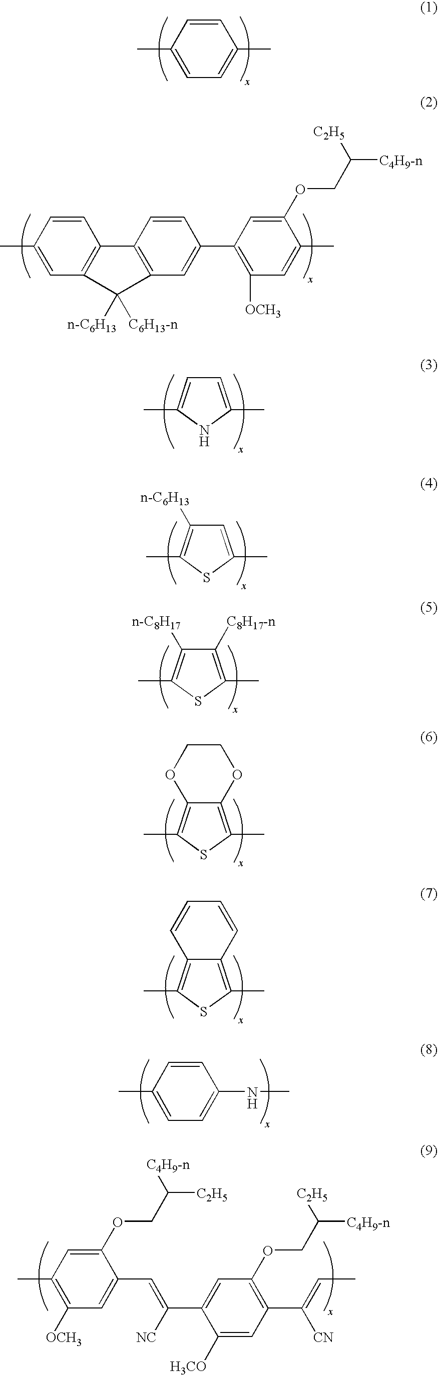

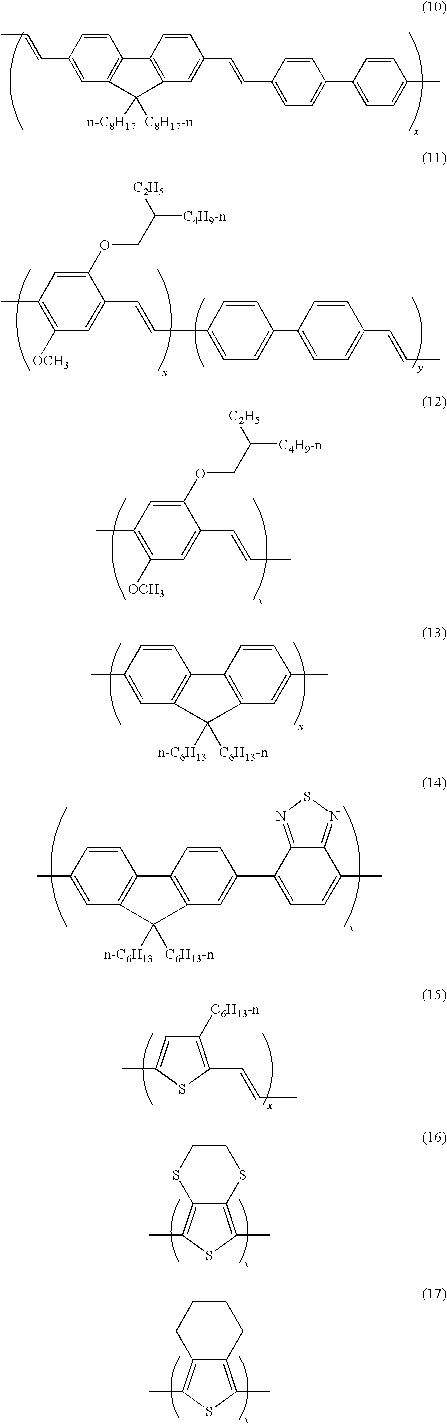

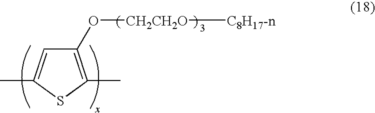

The weight average molecular weight of an electroconductive polymer to be used in the present invention is preferably from 1,000 to 1,000,000, more preferably from 10,000 to 500,000, and still more preferably from 10,000 to 100,000. The weight average molecular weight as used herein is a polystyrene-converted weight average molecular weight measured by gel permeation chromatography.

(2) Compound Represented by Formula (I)

The electroconductive film of the present invention includes the compound represented by the following Formula (1). The electroconductive film of the present invention including the compound represented by the following Formula (1) shows high transparency and high electroconductivity, and is excellent in durability under humidity and heat.

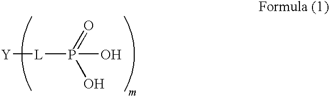

In Formula (1), Y is a hydrogen atom, a carbon atom, a hetero atom, a hydroxy group, a mercapto group, a group derived from an amino group, a group derived from an alkyl group, a group derived from an acyl group, a group derived from an aryl group, a group derived from an alkoxy group, a group derived from an aryloxy group, or a group derived from a heteroaryl group; L is a single bond, a divalent hydrocarbon group, a divalent hetero atom or an imino group; and m is an integer of 1 or more.

Each Y in Formula (1) may have substituents. Examples of the substituents may include Substituent Group V mentioned below.

(Substituent Group V)

Halogen atom (for example, chlorine, bromine, iodine, fluorine); a mercapto group; a cyano group; a carboxyl group; a phosphoric acid group; a sulfo group; a hydroxy group; carbamoyl groups having 1 to 10 carbon atoms, preferably having 2 to 8 carbon atoms, and more preferably having 2 to 5 carbon atoms (for example, a methylcarbamoyl group, an ethylcarbamoyl group and a morpholinocarbamoyl group); sulfamoyl groups having 0 to 10 carbon atoms, preferably having 2 to 8 carbon atoms, and more preferably having 2 to 5 carbon atoms (for example, a methylsulfamoyl group, an ethylsulfamoyl group and a piperidinosulfamoyl group); a nitro group; alkoxy groups having 1 to 20 carbon atoms, preferably having 1 to 10 carbon atoms, and more preferably having 1 to 8 carbon atoms (for example, a methoxy group, an ethoxy group, a 2-methoxyethoxy group and a 2-phenylethoxy group); aryloxy groups having 6 to 20 carbon atoms, preferably having 6 to 12 carbon atoms, and more preferably having 6 to 10 carbon atoms (for example, a phenoxy group, a p-methylphenoxy group, a p-chlorophenoxy group and a naphthoxy group); acyl groups having 1 to 20 carbon atoms, preferably having 2 to 12 carbon atoms, and more preferably having 2 to 8 carbon atoms (for example, an acetyl group, a benzoyl and a trichloroacetyl group); acyloxy groups having 1 to 20 carbon atoms, preferably having 2 to 12 carbon atoms, and more preferably having 2 to 8 carbon atoms (for example, an acetyloxy group and a benzoyloxy group); acylamino groups having 1 to 20 carbon atoms, preferably having 2 to 12 carbon atoms, and more preferably having 2 to 8 carbon atoms (for example, an acetylamino group);

sulfonyl groups having 1 to 20 carbon atoms, preferably having 1 to 10 carbon atoms, and more preferably having 1 to 8 carbon atoms (for example, a methanesulfonyl group, an ethanesulfonyl group and a benzenesulfonyl group); sulfinyl groups having 1 to 20 carbon atoms, preferably having 1 to 10 carbon atoms, and more preferably having 1 to 8 carbon atoms (for example, a methanesulfinyl group, an ethanesulfinyl group and a benzenesulfinyl group); sulfonylamino groups having 1 to 20 carbon atoms, preferably having 1 to 10 carbon atoms, and more preferably having 1 to 8 carbon atoms (for example, a methanesulfonylamino group, an ethanesulfonylamino group and a benzenesulfonylamino group); substituted or unsubstituted amino groups having 0 to 20 carbon atoms, preferably having 0 to 12 carbon atoms, and more preferably having 0 to 8 carbon atoms (for example, an unsubstituted amino group, a methylamino group, a dimethylamino, a benzylamino group, an anilino group and a diphenylamino group); ammonium groups having 0 to 15 carbon atoms, preferably having 3 to 10 carbon atoms, and more preferably having 3 to 6 carbon atoms (for example, a trimethylammonium group and a triethylammonium group); hydrazino groups having 0 to 15 carbon atoms, preferably having 1 to 10 carbon atoms, and more preferably having 1 to 6 carbon atoms (for example, a trimethylhydrazino group); ureido groups having 1 to 15 carbon atoms, preferably having 1 to 10 carbon atoms, and more preferably having 1 to 6 carbon atoms (for example, an ureido group and an N,N-dimethylureido group); imide groups having 1 to 15 carbon atoms, preferably having 1 to 10 carbon atoms, and more preferably having 1 to 6 carbon atoms (for example, a succinimide group);

alkylthio groups having 1 to 20 carbon atoms, preferably having 1 to 12 carbon atoms, and more preferably having 1 to 8 carbon atoms (for example, a methylthio group, an ethylthio group and a propylthio group); arylthio groups having 6 to 80 carbon atoms, preferably having 6 to 40 carbon atoms, and more preferably having 6 to 30 carbon atoms (for example, a phenylthio group, a p-methylphenylthio group, a p-chlorophenylthio group, a 2-pyridylthio group, a 1-naphthylthio group, a 2-naphthylthio group, a 4-propylcyclohexyl-4′-biphenylthio group, a 4-butylcyclohexyl-4′-biphenylthio group, a 4-pentylcyclohexyl-4′-biphenylthio group and a 4-propylphenyl-2-ethynyl-4′-biphenylthio group); heteroarylthio groups having 1 to 80 carbon atoms, preferably having 1 to 40 carbon atoms, and more preferably having 1 to 30 carbon atoms (for example, a 2-pyridylthio group, a 3-pyridylthio group, a 4-pyridylthio group, a 2-quinolylthio group, 2-furilthio group and a 2-pyrrolylthio group); alkoxycarbonyl groups having 2 to 20 carbon atoms, preferably having 2 to 12 carbon atoms, and more preferably having 2 to 8 carbon atoms (for example, a methoxycarbonyl group, an ethoxycarbonyl group and a 2-benzyloxycarbonyl group), aryloxycarbonyl groups having 6 to 20 carbon atoms, preferably having 6 to 12 carbon atoms, and more preferably having 6 to 10 carbon atoms (for example, a phenoxycarbonyl group);

unsubstituted alkyl groups having 1 to 18 carbon atoms, preferably having 1 to 10 carbon atoms, and more preferably having 1 to 5 carbon atoms (for example, a methyl group, an ethyl group, a propyl group and a butyl group); substituted alkyl groups having 1 to 18 carbon atoms, preferably having 1 to 10 carbon atoms, and more preferably having 1 to 5 carbon atoms (for example, a hydroxymethyl, a trifluoromethyl group, a benzyl group, a carboxyethyl group, an ethoxycarbonylmethyl group and an acetylaminomethyl group, wherein unsaturated hydrocarbon groups having 2 to 18 carbon atoms, preferably having 3 to 10 carbon atoms, and more preferably having 3 to 5 carbon atoms (for example, a vinyl group, an ethynyl group, a 1-cyclohexenyl group, a benzylidyne group and a benzylidene group) shall be included in the substituted alkyl groups); substituted or unsubstituted aryl groups having 6 to 20 carbon atoms, preferably having 6 to 15 carbon atoms, and more preferably having 6 to 10 carbon atoms (for example, a phenyl group, a naphthyl group, a p-carboxyphenyl group, a p-nitrophenyl group, a 3,5-dichlorophenyl group, a p-cyanophenyl group, a m-fluorophenyl group, a p-tolyl group, 4-propylcyclohexyl-4′-biphenyl, 4-butylcyclohexyl-4′-biphenyl, 4-pentylcyclohexyl-4′-biphenyl and 4-propylphenyl-2-ethynyl-4′-biphenyl); and substituted or unsubstituted heterocyclic groups having 1 to 20 carbon atoms, preferably having 2 to 10 carbon atoms, and more preferably having 4 to 6 carbon atoms (for example, a pyridyl group, a 5-methylpyridyl group, a thienyl group, a furil group, a morpholino group and a tetrahydrofurfuryl group) are included.

Substituents of the substituent group V may form a structure in which a benzene ring or a naphthalene ring is fused. Furthermore, such substituents may be additionally substituted. Such an additional substituent may be any one selected from the substituent group V.

In Formula (1), m is an integer of 1 or more. As mentioned below, where Y is a polyvalent group, m is identified according to the valency of Y.

Specifically, where Y is a carbon atom in Formula (1), m is 4. Where Y is a hetero atom, m is 3 where Y is a nitrogen atom, or m is 2 where Y is an oxygen atom or a sulfur atom. Where Y is a hydrogen atom, a hydroxy group or a mercapto group, m is 1.

The hetero atom represented by Y in Formula (1) is preferably a nitrogen atom, an oxygen atom, a sulfur atom or a selenium atom, and more preferably a nitrogen atom, an oxygen atom or a sulfur atom.

The group derived from an alkyl group represented by Y in Formula (1) includes monovalent (m=1) alkyl groups, as well as divalent (m=2) alkylene groups, and groups having three or more bonds. The same applies to the alkyl group existing in the group derived from an alkoxy group.

The group derived from an alkyl group represented by Y may be any of straight chain, branched and ring forms. The group derived from an alkyl group represented by Y has preferably 1 to 60 carbon atoms, more preferably 1 to 50 carbon atoms, and further preferably 1 to 40 carbon atoms.

Furthermore, the group derived from an alkyl group represented by Y in Formula (1) may be unsubstituted or may have substituents, and examples of the substituents may include Substituent Group V mentioned above. Among Substituent Group V, preferable substituents include a halogen atom (a fluorine atom, a chlorine atom, a bromine atom, an iodine atom), a hydroxy group, a mercapto group, an aryl group, a heteroaryl group, an acyl group, an alkoxy group, an amino group, a cyano group, a carboxyl group, a sulfo group, a carbamoyl group, a sulfamoyl group, a nitro group, an aryloxy group, an acyloxy group and an acylamino group; and more preferable substituents include a halogen atom (a fluorine atom), a hydroxy group, a mercapto group, an acyl group, an alkoxy group, an aryl group, a heteroaryl group, a sulfo group and an aryloxy group.

Specific examples of the group derived from an alkyl group represented by Y may include, for example, methyl, ethyl, t-butyl, t-octyl, 2-ethylhexyl, cyclohexyl, n-hexadecyl, 3-dodecyloxypropyl, perfluorobutyl, 3-(2,4′-di-tert-pentylphenoxy)propyl and the like where m=1; methylene, ethylene, methylhydroxymethylene, isobutylene and the like where m=2; and cyclohexanetriyl, cyclohexanetetrayl and the like where m=3 or more.

In Formula (1), the group derived from an acyl group represented by Y includes monovalent (m=1) formyl group, acetyl groups and the like, and a divalent (m=2) carbonyl group.

The group derived from an acyl group represented by Y in Formula (1) has preferably 1 to 60 carbon atoms, more preferably 1 to 50 carbon atoms, and further preferably 1 to 40 carbon atoms.

Furthermore, the group derived from an acyl group represented by Y may be unsubstituted or may have substituents. Examples of the substituents may include Substituent Group V mentioned above. Among Substituent Group V, preferable substituents include a halogen atom (a fluorine atom, a chlorine atom, a bromine atom, an iodine atom), an alkyl group, a hydroxy group, a mercapto group, an aryl group, a heteroaryl group, an acyl group, an alkoxy group, an amino group, a cyano group, a carboxyl group, a sulfo group, a carbamoyl group, a sulfamoyl group, a nitro group, an aryloxy group, an acyloxy group and an acylamino group; and more preferable substituents include a halogen atom, an alkyl group, a hydroxy group, a mercapto group, an aryl group and a heteroaryl group.

Specific examples of the group derived from an acyl group represented by Y may include, for example, acetyl, benzoyl, trichloroacetyl, phenylcarbonyl group, ethylcarbonyl group and the like where m=1; and carbonyl where the group is polyvalent.

In Formula (1), the group derived from an aryl group represented by Y includes monovalent (m=1) aryl groups (for example, a phenyl group, a naphthyl group and the like), divalent (m=2) arylenes (for example, phenylene group, naphthylene group and the like), and polyvalent groups such as a triyl group and a tetrayl group. For example, a group derived from an unsubstituted phenyl group may be monovalent to hexavalent. The same applies to the aryl group existing in the group derived from an aryloxy group.

The group derived from an aryl group represented by Y has preferably 6 to 60 carbon atoms, more preferably 6 to 50 carbon atoms, and further preferably 6 to 40 carbon atoms.

Furthermore, the group derived from an aryl group represented by Y may be unsubstituted or may have substituents, and examples of the substituents may include Substituent Group V mentioned above. Among Substituent Group V, preferable substituents include an alkyl group, an alkoxy group, a hydroxy group, a halogen atom (a fluorine atom, a chlorine atom, a bromine atom, an iodine atom), a mercapto group, an aryl group, a heteroaryl group, an acyl group, an amino group, a cyano group, a carboxyl group, a sulfo group, a carbamoyl group, a sulfamoyl group, a nitro group, an aryloxy group, an acyloxy group and an acylamino group. Alternatively, the group derived from an aryl group represented by Y may be a polymer such as polystyrene. Although the number of the repeating units in the polymer is not specifically limited, it is 1,000,000 or less, and more preferably 100,000 or less in view of solubility and electroconductivity of the electroconductive film. More preferable examples of the substituents for the group derived from an aryl group represented by Y include an alkyl group, an alkoxy group, a hydroxy group, a mercapto group, an acyl group, an amino group, a carboxyl group, a sulfo group and a nitro group.

Specific examples of the group derived from an aryl group represented by Y may include, for example, phenyl, 1-naphthyl, 4-tolyl, 4-methoxyphenyl, 4-hexadecyloxyphenyl, 3-pentadecylphenyl, 2,4-di-tert-pentylphenyl, 8-quinolyl, 5-(1-dodecyloxycarbonylethoxycarbonyl)-2-chlorophenyl and the like where m=1; and o-phenylene, m-phenylene, p-phenylene, 1,4-naphthylene, 9,10-anthrylene, 2-pentadecyl-1,4-phenylene and the like where the group is polyvalent.

The group derived from a heteroaryl group represented by Yin Formula (1) includes monovalent (m=1) heteroaryl groups, divalent (m=2) heteroarylenes, and polyvalent groups such as a triyl group and a tetrayl group.

In Formula (1), the heteroaryl group in the group derived from a heteroaryl group represented by Y is preferably a 5- to 8-membered heteroaryl group having at least one nitrogen atom, sulfur atom, oxygen atom or selenium atom as heteroatoms. Furthermore, the substituents possessed by the heteroaryl group may be linked each other to form a ring, such as formation of a condensed ring with an aromatic ring.

Furthermore, the group derived from a heteroaryl represented by Y may be unsubstituted or may have substituents, and examples of the substituents may include Substituent Group V mentioned above. Among Substituent Group V, preferable substituents include an alkyl group, an alkoxy group, a hydroxy group, a halogen atom (a fluorine atom, a chlorine atom, a bromine atom, an iodine atom), a mercapto group, an aryl group, a heteroaryl group, an acyl group, an amino group, a cyano group, a carboxyl group, a sulfo group, a carbamoyl group, a sulfamoyl group, a nitro group, an aryloxy group, arylthio group, an acyloxy group and an acylamino group; and more preferably an alkyl group, an alkoxy group, a hydroxy group, a mercapto group, an acyl group, an amino group, a carboxyl group, a sulfo group and a nitro group.

Specific examples of the group derived from a heteroaryl group represented by Y may include, for example, pyridyl, furyl, pyrrole, thiazolyl, oxazolyl, imidazolyl, triazolyl, tetrazolyl, benzotriazolyl, quinolyl and the like where m=1; and pyridinediyl, imidazolylene, pyrrolylene and isothiazolylene where the group is polyvalent.

Furthermore, the group derived from a heteroaryl group represented by Y may form a salt structure by converting the hetero atom to an ion. Examples may include an ammonium ion. Where the hetero atom is a cation such as an ammonium ion, examples of the counterion thereof may include a bromo ion, a chloro ion, a tetrafluoroborate ion, a hexafluorophosphate ion, a perchloric acid ion and a nitrate ion. Where the hetero atom is an anion, examples of the counterion thereof may include an ammonium ion, a sodium ion, a potassium ion and a calcium ion.

Where the group derived from an amino group represented by Y in Formula (1) is an amino group (NH₂—), m is 1; where the group is an imino group (—NH—), m is 2; and where the group is a substituted amino group, the group may become polyvalent according to the substituents. For example, in the case of an alkylamino group, the alkyl group possessed as a substituent may be a monovalent group as mentioned above, or a polyvalent group.

In Formula (1), the group derived from an amino group represented by Y has preferably 1 to 100 carbon atoms, more preferably 1 to 30 carbon atoms, and further preferably 1 to 10 carbon atoms.

The group derived from an amino group represented by Y may be unsubstituted or may have substituents, and examples of the substituents may include Substituent Group V mentioned above. Among Substituent Group V, preferable substituent include a hydroxy group, a sulfo group, an alkyl group, an aryl group, a heteroaryl group, an alkoxy group, a halogen atom (a fluorine atom, a chlorine atom, a bromine atom, an iodine atom), a mercapto group and a carboxyl group; and more preferably a hydroxy group, a sulfo group and an alkyl group.

Alternatively, the group derived from an amino group represented by Y may be an ammonium ion. Examples of the counterion thereof may include a bromo ion, a chloro ion, a tetrafluoroborate ion, a hexafluorophosphate ion, a perchloric acid ion and a nitric acid ion.

In Formula (1), the group derived from an alkoxy group represented by Y includes monovalent (m=1) alkoxy groups (for example, a methoxy group, an ethoxy group and the like), and groups in which the alkyl moiety of the alkoxy group is polyvalent. For example, where the alkyl moiety is an alkylene group, the group derived from an alkoxy group is divalent (m=2), and where the alkyl moiety is triylalkane, tetraylalkane or the like, the group is trivalent or more (m≧3). Furthermore, where the alkoxy group has substituents and is substituted by divalent (m=2) substituents or polyvalent substituents such as a triyl group and a tetrayl group, the group derived from an alkoxy group becomes a polyvalent group. For example, an alkoxy group substituted by a trivalent substituent becomes a divalent (m=2) group.

The group derived from an alkoxy group represented by Y in Formula (1) is an alkoxy group having preferably 1 to 60 carbon atoms, more preferably 1 to 50 carbon atoms, and further preferably 1 to 40 carbon atoms.

Furthermore, the group derived from an alkoxy group represented by Y may be unsubstituted or may have substituents, and examples of the substituents may include Substituent Group V mentioned above. Among Substituent Group V, preferable substituents include an alkyl group, an alkoxy group, a hydroxy group, a halogen atom (a fluorine atom, a chlorine atom, a bromine atom, an iodine atom), a mercapto group, an aryl group, a heteroaryl group, an acyl group, an amino group, a cyano group, a carboxyl group, a sulfo group, a carbamoyl group, a sulfamoyl group, a nitro group, an aryloxy group, an arylthio group, an acyloxy group and an acylamino group; and more preferable substituents include an alkyl group, an alkoxy group, a hydroxy group, a mercapto group, an aryl group and a heteroaryl group.

Specific examples of the group derived from an alkoxy group represented by Y may include, for example, methoxy, ethoxy, butoxy, methoxyethoxy, n-octyloxy and the like where m=1; and ethylenedioxy, propylenedioxy and the like where the group is polyvalent.

In Formula (1), the group derived from an aryloxy group represented by Y includes monovalent (m=1) aryloxy groups (for example, a phenoxy group and the like), and groups where the aryl moiety of the aryloxy group is polyvalent. For example, where the aryl moiety of the arylene group is trivalent, the group derived from an aryloxy group becomes divalent (m=2). Furthermore, where the aryloxy group has substituents and is substituted by polyvalent substituents such as a triyl group and a tetrayl group, the group derived from an aryloxy group becomes a polyvalent group. For example, an aryloxy group substituted by the group derived from the alkyl group in triyl becomes a divalent (m=2) group.

In Formula (I), the group derived from an aryloxy group represented by Y is an aryloxy group having preferably 6 to 60 carbon atoms, more preferably 6 to 50 carbon atoms, and further preferably 6 to 40 carbon atoms.

Furthermore, the group derived from an aryloxy group represented by Y may be unsubstituted or may have substituents, and examples of the substituents may include Substituent Group V mentioned above. Among Substituent Group V, preferable substituents include an alkyl group, an alkoxy group, a hydroxy group, a halogen atom (a fluorine atom, a chlorine atom, a bromine atom, an iodine atom), a mercapto group, an aryl group, a heteroaryl group, an acyl group, an amino group, a cyano group, a carboxyl group, a sulfo group, a carbamoyl group, a sulfamoyl group, a nitro group, aryloxy group, arylthio group, acyloxy group and an acylamino group; and more preferable substituents include an alkyl group, an alkoxy group, a hydroxy group, a mercapto group, an amino group, a carboxyl group and a sulfo group.

Specific examples of the group derived from an aryloxy group represented by Y may include, for example, phenoxy, 4-tert-octylphenoxy, naphthyloxy, pyrenyloxy and the like where m=1; and p-phenylenedioxy, naphthylenedioxy, 2-n-hexyl-1,4-phenylenedioxy and the like where the group is polyvalent.

In Formula (1), L is a single bond, a divalent hydrocarbon group, a divalent hetero atom or an imino group.

In Formula (1), the divalent hydrocarbon group represented by L has preferably 0 to 30 carbon atoms, more preferably 0 to 20 carbon atoms, and further preferably 0 to 10 carbon atoms. The divalent hydrocarbon group represented by L may have a ring structure and/or an unsaturated bond in the hydrocarbon structure, and is preferably a saturated hydrocarbon group. Furthermore, the divalent hydrocarbon group represented by L may be a straight chain or a branched chain, and is preferably a straight chain hydrocarbon group.

Moreover, the divalent hydrocarbon group represented by L may be unsubstituted or may have substituents, and is preferably an unsubstituted hydrocarbon group. Examples of the substituents may include Substituent Group V mentioned above. Among Substituent Group V, preferable substituents include a halogen atom (a fluorine atom, a chlorine atom, a bromine atom, an iodine atom), a hydroxy group, a mercapto group, an aryl group, a heteroaryl group, an acyl group, an alkoxy group, an amino group, a cyano group, a carboxyl group, a sulfo group, a carbamoyl group, a sulfamoyl group, a nitro group, an aryloxy group, an acyloxy group and an acylamino group; and more preferable substituents include a halogen atom (a fluorine atom), a hydroxy group, a mercapto group, an acyl group, an alkoxy group, an aryl group, a heteroaryl group, a sulfo group and an aryloxy group.

Specifically preferable divalent hydrocarbon group represented by L is an unsubstituted straight chain hydrocarbon group, and more preferably an unsubstituted straight chain hydrocarbon group having 0 to 10 carbon atoms.

In Formula (1), the divalent hetero atom represented by L is an oxygen atom, a sulfur atom, a selenium atom or a nitrogen atom, preferably an oxygen atom, a sulfur atom or a selenium atom, and more preferably an oxygen atom.

Specifically preferable L in Formula (1) is a single bond, a divalent hydrocarbon group, an oxygen atom, an imino group (—NH—, —NR— (R represents an alkyl group, an aryl group or a heteroaryl group), a sulfur atom or a selenium atom; and more preferably a single bond, an unsubstituted straight chain hydrocarbon group or an oxygen atom.

Hereinafter the specific examples of the compound represented by Formula (1) used for the present invention are shown, but the compound represented by Formula (1) in the present invention are not limited to those specific examples.

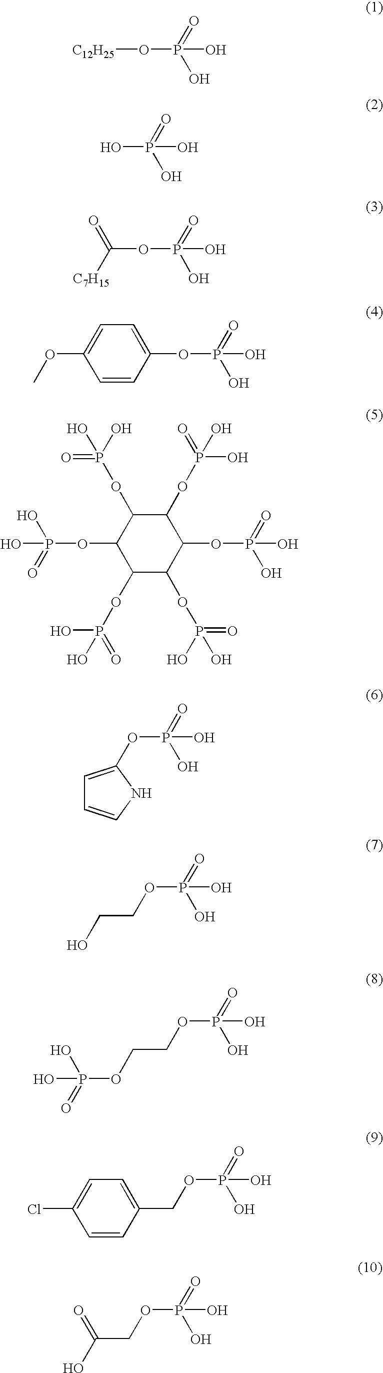

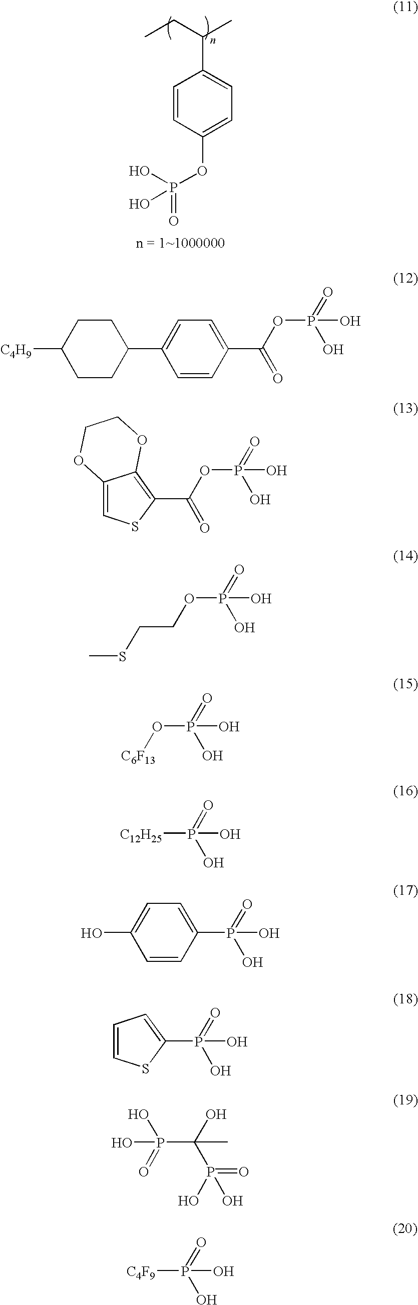

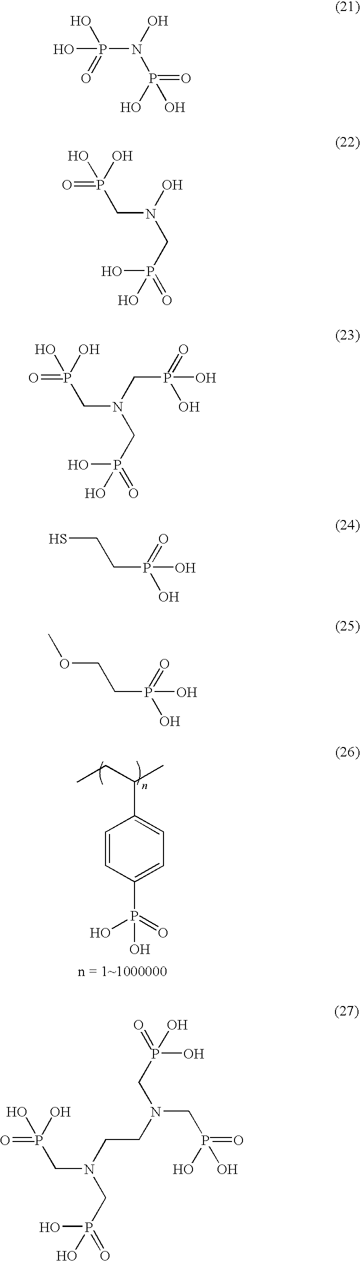

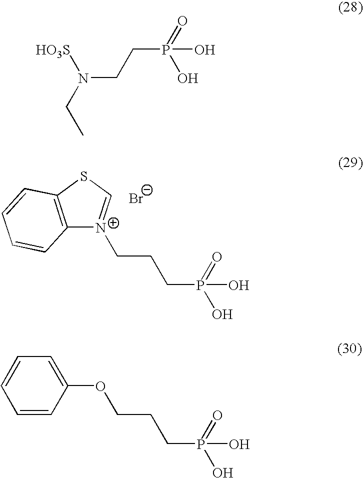

The compound represented by Formula (1) may be synthesized by a known method. Specifically, a synthesis method by reacting the alcohol or halogenated product that corresponds to the “Y-Lₘ” in Formula (1) with diphosphorus pentoxide or phosphoric acid is preferably used.

Some compounds represented by Formula (1) are available as commercial products, and examples include 1-hydroxyethane-1,1-diphosphonic acid (manufactured by Tokyo Chemical Industry Co., Ltd.), nitrilotris(methylenephosphonic acid) (manufactured by Tokyo Chemical Industry Co., Ltd.), phytic acid (manufactured by Tokyo Chemical Industry Co., Ltd.) and the like.

Although the ratio of the compound represented by Formula (1) to the electroconductive polymer (the compound represented by Formula (1):the electroconductive polymer) in the electroconductive film of the present invention may be any ratio, it is preferably within the range of from 0.00001:1.0 to 1000:1, preferably within the range of from 0.0001:1.0 to 500:1, and more preferably within the range of from 0.0005:1.0 to 100:1 by mass ratio, in view of balance between high electroconductivity and high durability.

In the cases of the electroconductive films wherein the compound represented by Formula (1) is localized on the surface of the film as shown in FIGS. 1 and 2, the compound represented by Formula (1) may be used in a wilder amount range than that in the electroconductive film shown in FIG. 3.

Specifically, in the case of the electroconductive film of FIGS. 1 or 2, the weight ratio of the compound represented by Formula (1) to the electroconductive polymer (the compound represented by Formula (1):the electroconductive polymer) may be used within the range of from 0.00001:1.0 to 10000:1, preferably within the range of from 0.0001:1 to 1000:1, and more preferably within the range of from 0.0005:1 to 500:1, in view of improvement of durability under humidity and heat.

(The Other Additives)

### —Dopant—

From the viewpoint that the dispersibility of the electroconductive polymer in a solvent is improved, it is preferable that the electroconductive film contains at least one dopant. The electroconductive polymer layer is suitably formed by coating as described below. To obtain a dispersion liquid (composition) with favorable dispersibility is important from the viewpoint of production. The dopant as used herein means an additive which has an action of changing the electrical conductivity of an electroconductive polymer. Such dopants include electron-accepting (i.e., acceptor) dopants and electron-donating (i.e., donor) dopants.

Examples of electron-accepting (i.e., acceptor) dopants include halogens (Cl₂, Br₂, I₂, ICl, ICl₃, IBr, IF), Lewis acids (PF₅, AsF₅, SbF₅, BF₃, BCl₃, BBr₃, SO₃), proton acids (HF, HCl, HNO₃, H₂SO₄, HClO₄, FSO₃H, CISO₃H, CF₃SO₃H, various organic acids, amino acids, and the like), transition metal compounds (FeCl₃, FeOCl, TiCl₄, ZrCl₄, HfCl₄, NbF₅, NbCl₅, TaCl₅, MoF₅, MoCl₅, WF₆, WCl₆, UF₆, LnCl₃ (Ln is lanthanide, such as La, Ce, Pr, Nd, and Sm), electrolyte anions (Cl⁻, Br, I⁻, ClO₄⁻, PF₆⁻, AsF₆⁻, SbF₆⁻, BF₄⁻, various sulfonate anions), O₂, XeOF₄ (NO₂⁺)(SbF₆⁻), (NO₂⁺)(SbCl₆⁻), (NO₂⁻)(BF₄⁻), FSO₂OOSO₂F, AgClO₄, H₂IrCl₆ and La(NO₃)₃.6H₂O.

Examples of electron-donating (i.e., donor) dopants include alkali metals (Li, Na, K, Rb, Cs), alkaline earth metals (Ca, Sr, Ba), lanthanides (Eu, or the like), and others (R₄N⁺, R₄P⁻, R₄As⁺, R₃S⁺, acetylcholine).

Examples of the combination of the dopant and the electroconductive polymer include:
(A) polyacethylene with I₂, AsF₅, FeCl₃ or the like;
(B) poly(p-phenylene) with AsF₅, K, AsF₆⁻ or the like;
(C) polypyrrole with ClO₄⁻ or the like;
(D) polythiophenes with ClO₄⁻, or a sulfonic acid compound, especially polystyrene sulfonic acid, a nitrosonium salt, an aminium salt, a quinone, or the like;
(E) polyisothianaphthene with I₂ or the like;
(F) poly(p-phenylene sulfide) with AsF₅;
(G) poly(p-phenyleneoxide) with AsF₅;
(H) polyaniline with HCl or the like;
(I) poly(p-phenylenevinylene) with H₂SO₄ or the like;
n(J) polythiophenylenevinylene with I₂ or the like;
(K) nickel phthalocyanine with I₂.

Among these combinations, preferred is the combination (D) or (H), more preferred, from the viewpoint that the dope condition is high in stability, is the combination of polythiophenes (polythiophene or its derivative) with a sulfonic acid compound, and still more preferred, from the viewpoint that the aqueous dispersion liquid may be prepared whereby an electroconductive thin film may be prepared easily by coating, is the combination of a polythiophenes with a polystyrene sulfonic acid.

The ratio of the electroconductive polymer to the dopant may be any value. From the viewpoint of well achieving both the stability of the dope condition and the electrical conductivity, the weight ratio of the electroconductive polymer to the dopant (electroconductive polymer: dopant) is preferably within the range of from 1.0:0.000000 1 to 1.0:10, more preferably within the range of from 1.0:0.00001 to 1.0:1.0, and still more preferably within the range of 1.0:0.0001 to 1.0:0.5.

In order to improve the dispersibility of an electroconductive polymer, an ion-conductive polymer in which polymer chain has been doped with an electrolyte may be used. Examples of such a polymer chain include polyethers (polyethylene oxide, polypropylene oxide, and the like), polyesters (polyethylene succinate, poly-β-propiolactone, and the like), polyamines (polyethyleneimine, and the like), and polysulfides (polyalkylene sulfide, and the like). The electrolyte doped may be various alkali metal salts.

Examples of the alkali metal ion which constitutes the alkali metal salt include Li⁺, Na⁺, K⁺, Rb⁺ and Cs⁺. Examples of the anion which forms the counter salt include F⁻, Cl⁻, Br⁻, I⁻, NO₃⁻, SCN⁻, ClO₄⁻, CF₃SO₃⁻, BF₄⁻, AsF₆⁻ and BPh₄⁻.

Examples of the combination of the polymer chain and the alkali metal salt include polyethylene oxide with LiCF₃SO₃, LiClO₄ or the like; polyethylene succinate with LiClO₄, LiBF₄; poly-β-propiolactone with LiClO₄ or the like; polyethyleneimine with NaCF₃SO₃, LiBF₄ or the like; and polyalkylene sulfide with AgNO₃ or the like.

—The Other Additives—

It is also possible to additionally add a solvent, described below, and other additives to the electroconductive film of the present invention. The available additives include UV absorbers, phosphite ester, hydroxamic acid, hydroxyamine, imidazole, hydroquinone, phthalic acid and the like for the purpose of suppressing decomposition of the polymer, inorganic fine particles and polymer particles for the purpose of increasing the film strength, silane coupling agents, and fluorine-containing compounds (especially, fluorine-containing surfactants) for the purpose of reducing a refractive index and increasing transparency simultaneously.

A diol compound is preferably added to a electroconductive film of the present invention from the viewpoint of decreasing electric resistance value. A diol compound signifies a compound containing two or more hydroxy groups in a molecule; examples thereof include ethylene glycol, glycerin, propylene glycol, diethylene glycol, triethylene glycol, sugar (such as fructose), hydroquinone, gallic acid and catechol; preferably ethylene glycol.

The added amount of the above-mentioned diol compound in an electroconductive film of the present invention is preferably from 0.01 to 99% by mass, more preferably from 0.1 to 98% by mass, and still more preferably from 1 to 90% by mass.

The compounding ratio of the electroconductive polymer and the diol compound (electroconductive polymer: diol compound) may be any one, preferably within the range of from 1:1000 to 1000:1 by mass ratio, more preferably a range of from 1:100 to 100:1, and still more preferably a range of from 1:10 to 10:1 from the viewpoint of compatibility between costs and conductivity.

The diol compound may be added to the film 3 shown in FIGS. 1 and 2 or to the electroconductive film 5 shown in FIG. 3, or may be localized on the surface of the film 3 or the electroconductive film 5 as in the compound 4 represented by Formula (1) in FIGS. 1 and 2. Preferably, the diol compound is localized on the surface of the film 3 or the electroconductive film 5. In the cases of the electroconductive films 1 and 2 in FIGS. 1 and 2, it is more preferable to add the diol compound to the film 3 containing an electroconductive polymer and then add the compound 4 represented by Formula (1) in this order, in view of improvement of durability under humidity and heat.

Where the diol compound has a low molecular weight, it does not need to form a layer as a result of volatilization.

<Electroconductive Polymer Composition>

The electroconductive polymer composition of the present invention contains at least (1) an electroconductive polymer or a precursor thereof, and (2) the compound represented by Formula (1).

As the electroconductive polymer included in the electroconductive polymer composition, the above-mentioned electroconductive polymer may be used, and the preferable range is the same. As used herein, the “precursor of the electroconductive polymer” means a monomer or oligomer for obtaining the electroconductive polymer. For example, where the electroconductive polymer is poly(3,4-ethylenedioxy)thiophene (PEDOT), its precursor is 3,4-ethylenedioxy-thiophene (EDOT) or an oligomer thereof.

It is preferable to use a precursor of the electroconductive polymer for the electroconductive polymer composition of the present invention in view of preparation of an electroconductive film having high transparency, and it is further preferable to add the precursor as a monomer to the electroconductive polymer composition and polymerize the composition after coating.

As the compound represented by Formula (1) included in the electroconductive polymer composition, the compound represented by Formula (1) mentioned above may be used, and the preferable range is the same.

In the electroconductive polymer composition of the present invention, the method for adding the electroconductive polymer and the compound represented by Formula (1) may be any method. For example, a solution in which the compound represented by Formula (1) has been dissolved and a dispersion liquid in which the electroconductive polymer has been dispersed may be mixed so that the compound represented by Formula (1) and the electroconductive polymer are uniformly mixed.

In the electroconductive polymer composition, a content ratio of the compound represented by Formula (1) and the electroconductive polymer (compound represented by Formula (1):electroconductive polymer) is within the range of from 0.00001:1.0 to 1000:1, preferably in the range of 0.0001:1.0 to 500:1, and more preferably in the range of 0.0005:1.0 to 100:1 by mass ratio, in view of balance between high electroconductivity and high durability.

Furthermore, the above-mentioned dopant and additives may be added to the electroconductive polymer composition of the present invention. Their amounts to be added are also as mentioned above.

<Electroconductive Polymer Material>

The electroconductive polymer material of the present invention has a substrate, and a layer containing the compound represented by Formula (1) and the electroconductive polymer provided on or above the substrate.

Other embodiment of the electroconductive polymer material of the present invention has a substrate, and a layer containing the above-mentioned electroconductive polymer and a layer containing the compound represented by Formula (1) provided on or above the substrate.

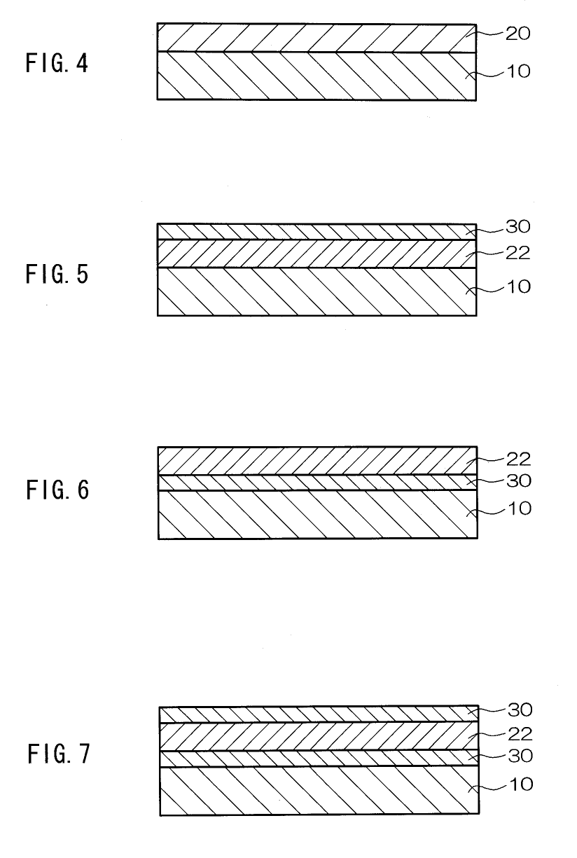

Specific examples of the layer structures of the electroconductive polymer material are shown in FIGS. 4 to 7. The electrode material of FIG. 4 has support 10 and layer 20 including the compound represented by Formula (1) and the electroconductive polymer (hereinafter referred to as “first electroconductive polymer layer”) provided on or above the support 10. Furthermore, a protective layer (not depicted) and an intermediate layer (not depicted) may be provided. The electroconductive polymer materials of FIGS. 5 to 7 has the support 10, and a layer 22 containing the electroconductive polymer (hereinafter referred to as “second electroconductive polymer layer”) and a layer 30 containing the compound represented by Formula (1) (hereinafter referred to as “additive layer”) provided on or above the support 10. Furthermore, a protective layer (not depicted) and an intermediate layer (not depicted) may be provided.

Although the electroconductive polymer materials containing one first electroconductive polymer layer 20 or one second electroconductive polymer layer 22, and one additive layer 30 are shown in FIGS. 4 to 6, two or more of each layer may be used.

In the following explanations, the electroconductive polymer material of the aspect of FIG. 4 is referred to as “electroconductive polymer material of the first exemplary embodiment”, and the electroconductive polymer materials of the aspects of FIGS. 5 to 7 are referred to as “electroconductive polymer material of the second exemplary embodiment”.

### First Exemplary Embodiment

The electroconductive polymer material of the first exemplary embodiment represented by FIG. 4 has the support 10, and the layer (first electroconductive polymer layer) 20 containing the compound represented by Formula (1) and the electroconductive polymer provided on or above the support 10. The first electroconductive polymer layer 20 is the above-mentioned electroconductive film, or a layer formed by the above-mentioned electroconductive polymer composition.

(1) Support

Any material which is in the form of a stable panel and which satisfies required flexibility, strength, durability may be used as the support 10 capable of being used in the present invention. In the event that the resulting electroconductive polymer material is used in an image display device, a solar cell, or the like, a high transparency is required and therefore the use of a transparent substrate with a smooth surface is preferred as a support.

In the present invention, examples of the material of the support 10 include glass, transparent ceramics, metal and plastic film. Glass and transparent ceramics are inferior in plasticity to metal and plastic film. Plastic film is less expensive than metal and has plasticity. Therefore, plastic film is preferred as the support 10 of the present invention. In particular, polyester-based resins (hereinafter, suitably referred to as “polyesters”) are preferred. As the polyesters, preferred are linear saturated polyesters which are synthesized from an aromatic dibasic acid or its ester-forming derivative with a diol or its ester-forming derivative.

Specific examples of the polyesters which may be used for the present invention include polyethylene terephthalate, polyethylene isophthalate, polyethylene naphthalate, polybutylene terephthalate, poly(1,4-cyclohexylenedimethylene terephthalate) and polyethylene 2,6-phthalene dicarboxylate. Among these, polyethylene terephthalate, polyethylene naphthalate are preferred from the viewpoint of easy availability, economical efficiency and effect.

Moreover, a mixture of these copolymers or a mixture of these polymers and other resins in a small proportion may also be used as the material of a film, unless the effect of the present invention is impaired.

Furthermore, for the purpose of improving a smoothness, it is permissible to cause the polyester film to contain a small amount of inorganic or organic particles, for example, inorganic fillers, such as titanium oxide, calcium carbonate, silica, barium sulfate and silicone; organic fillers, such as acryls, benzoguanamine, Teflon (registered trademark) and epoxy resin. Adhesive improvers or antistatic agents, such as polyethylene glycol (PEG) and sodium dodecylbenzene sulfonate may be included into the polyester film.

The polyester film to be used for the present invention may be produced by forming a polyester resin like that mentioned above into a film shape by melt extrusion. As the method and condition regarding the production of such films, conventional methods and conditions may be selected preferably and used.

Examples of a substrate that satisfies necessary flexibility, strength, durability and light transmitting property and being excellent in the transmitting property of the wavelength at the visible light area may include films using resins such as cellulose diacetate, cellulose triacetate, cellulose propionate, cellulose butyrate, cellulose acetate butyrate, nitrocellulose, polyethylene terephthalate, polyethylene, polystyrene, polypropylene, polycarbonate, polyvinyl acetal and polyarylate. Of these, where the present invention is applied to liquid crystal display panels and the like, polycarbonate, polyarylate and the like are preferable in view of optical property and heat property.

The thickness of the support may be selected preferably, and it generally is within the range of from 5 ∞m to 500 μm.

An adhesive layer may be formed in order to improve the adhesiveness of the electroconductive polymer layer on the support 10. Particularly when the support 10 is formed from polyester resins, it is preferable that an adhesive layer is provided. The adhesive layer may be selected from any materials, and preferably a configuration containing a styrene-butadiene copolymer (hereinafter, preferably, referred to as “SBR”) or an aqueous urethane resin and a crosslinking agent. The SBR means a copolymer obtained by mainly copolymerizing styrene and butadiene and other component as required. In the copolymer, it is known that, when a content ratio of styrene and butadiene is controlled, copolymers having various physical properties are obtained.

In the case where an adhesive layer is provided in the present invention, a styrene-butadiene copolymer is preferably latex. Specifically, commercially available products which are supplied from Nippon Zeon Co., Ltd. under the trade name of NIPOL, from Sumitomo Naugatuck Co., Ltd. under the trade name of NAUGATEX, from Takeda Chemical Industries, Ltd. under the trade name of CROSLENE, from Asahi-Dow Ltd. under the trade name of ASAHI DOW LATEX, and from Dainippon Ink & Chemicals, Inc. and overseas manufacturers may also be used.

A particle diameter of dispersed particles of the latex is preferably 5 μm or less, more preferably 1 μm or less, and still more preferably 0.2 μm or less. When the particle diameter is in the range, particles are difficult to aggregate in a coating step, and the transparency and glossiness of the film are also excellent. When a thickness of a coating layer is required to be thinner, a particle diameter is preferably made smaller accordingly.

Regarding a styrene-butadiene copolymer contained in the adhesive layer, a content ratio of styrene/butadiene is preferably substantially from 50/50 to 80/20. A ratio of SBR contained in the latex is preferably from 30% to 50% by mass by solid content.

In the adhesive layer, a crosslinking agent is added in order to improve the physical properties of the SBR. As the crosslinking agent, a triazine-based crosslinking agent is preferred.

(2) First Electroconductive Polymer Layer

The first electroconductive polymer layer 20 contains at least the compound represented by Formula (1) and the electroconductive polymer. The first electroconductive polymer layer 20 may further contain the above-mentioned additives. Although the film thickness of the first electroconductive polymer layer 20 is not specifically limited, it is preferably in the range of from 1 nm to 2 μm, and more preferably in the range of from 10 nm to 1 μm. Where the film thickness of the first electroconductive polymer layer 20 is in this range, sufficient electroconductivity and transparency may be achieved.

As the first electroconductive polymer layer 20, the electroconductive film 1 of Fig. 1, the electroconductive film 2 of FIG. 2, or the electroconductive film 5 of FIG. 3 may be used.

It is preferable to form the first electroconductive polymer layer 20 by coating in view of that an electrode material having a large area may be prepared at a time. Examples of methods other than coating may include spin coating, transferring and the like. The coating liquid may be an aqueous dispersion or an organic solvent. As the coating liquid for forming the first electroconductive polymer layer 20 (hereinafter referred to as “electroconductive polymer coating liquid (1)”), the above-mentioned electroconductive polymer composition may be used.

Furthermore, a solvent for coating or the above-mentioned dopant is suitably added to the electroconductive polymer composition for forming the first electroconductive polymer layer 20 in accordance with the situation. In addition, the above-mentioned additives may be added.

The electroconductive polymer coating liquid (1) may be prepared separately by preparing a dispersion in which the electroconductive polymer has been dispersed and a solution in which the compound represented by Formula (1) has been dissolved, in advance, and mixing these liquids, and the coating liquid is formed into a film at a time.

Examples of the solvent used for the electroconductive polymer dispersion liquid may include water, alcohols, ethers, ketones, esters, hydrocarbons, halogenated hydrocarbons, amides and the like. Water and lower alcohols are preferable in view of cost, and water is preferable in consideration of environment.

Where water is used as a solvent, a known method may be applied as a method for dispersing the electroconductive polymer. Examples of the dispersion method may include jaw crusher method, ultracentrifugal pulverizing method, cutting mill method, automatic mortar method, disc mill method, ball mill method, dispersion methods such as ultrasonic dispersion method, and the like.

As the solvent for dissolving the compound represented by Formula (1), methanol, ethanol, isopropanol, n-butanol, ethylene glycol, triethylene glycol, dimethylformamide, dimethylsulfoxide, water or the like may be used. It is preferable to use methanol, ethanol, ethylene glycol or water in view of cost and coating property.

The concentration of the electroconductive polymer in the electroconductive polymer coating liquid (1) is desirably adjusted properly consideration of viscosity and the like. Generally, the concentration is preferably from 0.0 1 mass % to 50 mass %, and more preferably from 0.1 mass % to 10 mass %.

The concentration of the compound represented by Formula (1) in the electroconductive polymer coating liquid (1) is desirably adjusted properly in consideration of viscosity and the like. Generally, the concentration is preferably from 0001 mass % to 50 mass %, and more preferably from 0.01 mass % to 10 mass %.

Furthermore, it is preferable to add the above-mentioned diol compound to the electroconductive polymer coating liquid (1) in view of decreasing electrical resistance.

The first electroconductive polymer layer 20 is formed by coating the electroconductive polymer coating liquid (1). As the coating method, for example, a known coating methods such as an extrusion die coater, an air doctor coater, a bread coater, a rod coater, a knife coater, a squeeze coater, a reverse roll coater and a bar coater may be adopted.

A layer containing the above-mentioned diol compound such as ethylene glycol (hereinafter referred to as ‘a diol compound layer’) (not shown in Fig.) may be provided on or above the support 10 separately from the electroconductive polymer layer 20. Coating solution for forming the diol compound layer (hereinafter referred to as ‘a diol compound layer coating solution’) contains at least the above-mentioned diol compound, additionally, a solvent for the application is properly added in accordance with the situation. In addition thereto, an additive may be further added. Examples of an additive further contained include an ultraviolet absorbing agent; inorganic particulates or polymer particulates, for the purpose of improving film strength; a silane coupling agent; a fluorine compound, particularly a fluorine surface-active agent for the purpose of decreasing refractive index to improve transparency.

Examples of solvent for a diol compound layer coating solution include water, alcohol, ether, ketone, ester, hydrocarbon, halogenated hydrocarbon or amide; preferably water or lower alcohol from the viewpoint of costs; and more preferably water in consideration of environment.

The concentration of the diol compound in a diol compound layer coating solution is desirably adjusted properly in consideration of viscosity; generally, preferably from 1% to 100% by mass, and more preferably from 5% to 100% by mass.

In the case of forming the diol compound layer, it is preferable from the viewpoint of electrical conductivity that the diol compound layer is formed on the support 10 to form the electroconductive polymer layer 20 on the diol compound layer, or the electroconductive polymer layer 20 is formed on the support to form the diol compound layer on the electroconductive polymer layer 20. In addition, in the case of further forming the adhesive layer, it is preferable to provide in order of the adhesive layer, the diol compound layer and the first electroconductive polymer layer 20; or in order of the adhesive layer, the first electroconductive polymer 20 layer and the diol compound layer from the support side.

In the case where the diol compound is low in molecular weight, the layer need not be formed by reason of volatilizing.

In the case where a layer such as the plural first electroconductive polymer layer are formed on or above the support 10, each layer may be applied and dried repeatedly, or plural layers may be formed by simultaneous multilayer coating. Simultaneous multilayer coating is preferable from the viewpoint of decreasing production costs and the shortening production time. Here, ‘simultaneous multilayer coating’ signifies that two coating solutions are applied in a contact condition.

Furthermore, where other layer such as an intermediate layer is provided, the intermediate layer and the like and the first electroconductive polymer layer may be applied and dried by each layer, or two or more layers may be formed by simultaneous multilayer coating.

The above-mentioned simultaneous multilayer coating may be performed by curtain coater, slide coater or extrusion coater, preferably curtain coater among them.

### Second Exemplary Embodiment

The electroconductive polymer material of the second exemplary embodiment has the support 10, and a layer 22 containing the electroconductive polymer (second electroconductive polymer layer) and a layer 30 containing the compound represented by Formula (1) ( hereinafter referred to as “additive layer”) provided on or above the support.

The layer constitution of the electroconductive polymer material of the second exemplary embodiment is not limited as long as it has the support 10, and at least one second electroconductive polymer layer 22 and at least one additive layer 30 provided on or above the substrate.

For example, in FIG. 5, the second electroconductive polymer layer 22 is provided on the support 10, and the additive layer 30 is provided on the second electroconductive polymer layer 22. As shown in FIG. 6, the additive layer 30 and the second electroconductive polymer layer 22 may be laminated in this order from the support 10 on the support 10. Alternatively, as shown in FIG. 7, the additive layer 30, the second electroconductive polymer layer 22, and the additive layer 30 may be laminated in this order from the support 10 on the support 10. Moreover, although not depicted, the additive layer 30 and the second electroconductive polymer layer 22 may be laminated repeatedly on the support in an alternate manner.

In view of improvement of durability under humidity and heat, it is preferable to provide the additive layer 30 on the boundary contacting with air, as shown in FIGS. 5 and 7.

An intermediate layer may be provided between each layer. It is preferable to provide the second electroconductive polymer layer 22 and the additive layer 30 in the adjacent manner in view of improvement of the film property. Furthermore, it is more preferable to provide two additive layers 30 on both surfaces of the second electroconductive polymer layer 22 so that the second electroconductive polymer layer is interposed between the two additive layers as shown in FIG. 7, in view of further improvement of the film property.

(1) Suppot

The support 10 that may be used in the second exemplary embodiment is the same as the substrate that that may be used in the first exemplary embodiment, and preferable substrate is the same.

(2) Second Electroconductive Polymer Layer 22

The second electroconductive polymer layer 22 contains at least the electroconductive polymer, and may further contain the above-mentioned additives.

It is preferable to form the second electroconductive polymer layer 22 by coating in view of convenience that an electrode material having a large area may be prepared at a time. Examples of method other than coating may include transferring and the like. The coating liquid may be an aqueous dispersion or an organic solvent.

Besides the electroconductive polymer, a solvent for coating and the above-mentioned dopant are suitably added to the coating liquid for forming the second electroconductive polymer layer 22 (hereinafter referred to as “electroconductive polymer coating liquid (2)”) in accordance with the situation. In addition, the above-mentioned additives may be added. Furthermore, it is preferable to add the above-mentioned diol compound to the electroconductive polymer coating liquid (2) in view of decreasing electrical resistance.

Since the second electroconductive polymer layer 22 and the layer 30 containing the compound represented by Formula (1) (additive layer) are provided separately in the electroconductive polymer material of the second exemplary embodiment, it is not necessary to add the compound represented by Formula (1) to the second electroconductive polymer layer 22, but may be added.

Furthermore, where the second electroconductive polymer layer 22 contains the compound represented by Formula (1), the electroconductive film 1 of FIG. 1, the electroconductive film 2 of FIG. 2, or the electroconductive film 5 of FIG. 3 may be applied as the second electroconductive polymer layer 22.

As a solvent of the electroconductive polymer coating liquid (2), water, alcohols, ethers, ketones, esters, hydrocarbons, halogenated hydrocarbons or amides may be used. Water or lower alcohols are preferred from the viewpoint of the cost, and water is more preferably used from the viewpoint of environment.

In the case where water is used as a solvent, as a method of dispersing the electroconductive polymer, known methods may be used. Examples of the dispersing method include a jaw crusher method, an ultracentrifugal pulverizing method, a cutting mill method, an automatic pestle method, a disc mill method, a ball mill method and an ultrasonic dispersion method.

The concentration of the electroconductive polymer in the electroconductive polymer coating liquid (2) desirably adjusted properly consideration of viscosity and the like. Generally, the concentration is preferably 0.01% to 50% by mass, and more preferably 0.1% to 10% by mass.

The electroconductive polymer coating solution (2) is applied to form the second electroconductive polymer layer 22. Examples of an application method include known application methods such as extrusion die coater, air-doctor coater, blade coater, rod coater, knife coater, squeeze coater, reverse-roll coater and bar coater.

Although the film thickness of the second electroconductive polymer layer 22 is not specifically limited, it is preferably in the range of 1 nm to 2 μm, and more preferably in the range of 10 nm to 1 μm. Where the film thickness of the second electroconductive polymer layer 22 is in this range, sufficient electroconductivity and transparency may be achieved.

(3) Layer (Additive Layer) 30 Containing the Compound Represented by Formula (1)

The layer (additive layer) 30 containing the compound represented by Formula (1) contains at least the compound represented by Formula (1), and may further contain the above-mentioned additives.

It is preferable to form the additive layer 30 by coating in view of convenience that an electrode material having a large area may be prepared at a time. Examples of method other than coating may include transferring and the like. The coating liquid may be an aqueous dispersion or an organic solvent.

Besides the compound represented by Formula (1), a solvent for coating is suitably added to the coating liquid for forming the additive layer 30. In addition, the above-mentioned additives may be added.

Since the second electroconductive polymer layer 22 and the layer containing the compound represented by Formula (1) are provided separately in the electroconductive polymer material of the second exemplary embodiment, it is not necessary to add the electroconductive polymer to the additive layer 30, but the electroconductive polymer may be added.

As a solvent for forming the additive layer containing the compound represented by Formula (1), water, alcohols, ethers, ketones, esters, hydrocarbons, halogenated hydrocarbons or amides may be used. Specifically, methylethylketone, methanol, ethanol, isopropanol, ethylene glycol or water may be used. Water or lower alcohols are preferred from the viewpoint of the cost, and water is more preferably used from the viewpoint of environment.

In the case where water is used as a solvent, as a method of dispersing the electroconductive polymer, known methods may be used. Examples of the dispersing method include a jaw crusher method, an ultracentrifugal pulverizing method, a cutting mill method, an automatic mortar method, a disc mill method, a ball mill method and dispersion methods such as ultrasonic dispersion method, and the like.

It is desirable to suitably adjust the concentration of the compound represented by Formula (1) in the coating liquid for forming the additive layer 30 in view of electroconductivity, transparency, durability and the like. Generally, the concentration is preferably 0.00001% to 100% by mass, and more preferably 0.0001% to 50% by mass.

The obtained coating liquid containing the compound represented by Formula (1) is applied to form an electroconductive polymer layer. Examples of an application method include known application methods such as extrusion die coater, air-doctor coater, blade coater, rod coater, knife coater, squeeze coater, reverse-roll coater and bar coater.

Although the film thickness of the layer 30 containing the compound represented by Formula (1) is not specifically limited, it is preferably in the range of from 1 nm to 2 μm, and more preferably in the range of from 10 nm to 1 μm. Where the film thickness of the second electroconductive polymer layer 22 is in this range, sufficient electroconductivity and transparency may be achieved.

Furthermore, the electroconductive polymer material of the second exemplary embodiment may also have the above-mentioned diol compound layer, in the same manner of the electroconductive polymer material of the first exemplary embodiment.

Where the diol compound layer is formed on the electroconductive polymer material of the second exemplary embodiment, it may have a layer constitution as follows.

(1) The second electroconductive polymer layer 22, the diol compound layer and the layer 30 containing the compound represented by Formula (1) are laminated in this order from the support 10.

(2) The second electroconductive polymer layer 22, the layer 30 containing the compound represented by Formula (1) and the diol compound layer are laminated in this order from the support 10.

(3) The layer 30 containing compound represented by Formula (1), the second electroconductive polymer layer 22 and the diol compound layer are laminated in this order from the support 10.

(4) The second electroconductive polymer layer 22, the diol compound layer and the layer 30 containing compound represented by Formula (1), and the diol compound layer are laminated in this order from the support 10.

Of the above-mentioned layer constitutions (1) to (4), the layer constitution of(1) is preferable in view of electroconductivity. Where the diol compound has a low molecular weight, a layer does not have to form a layer as a result of volatilization.

The second electroconductive polymer layer 22 and the additive layer 30 may be applied and dried on or above the support 10 by every one layer, or two or more layers may be formed by simultaneous multilayer coating.

Where two or more of the second electroconductive polymer layers 22 and/or two or more of the additive layers 30 are formed on or above the support 10, the layers may be applied and dried by every one layer, or two or more layers may be formed by simultaneous multilayer coating.

In the case where other layer such as an intermediate layer is formed on or above the support 10 by two layers or more, each layer may be applied and dried repeatedly, or two layers or more may be formed by simultaneous multilayer coating. Simultaneous multilayer coating is preferable from the viewpoint of decreasing production costs and the shortening production time. Here, ‘simultaneous multilayer coating’ signifies that two coating solutions are applied in a contact condition. The above-mentioned simultaneous multilayer coating may be performed by curtain coater, slide coater or extrusion coater, preferably curtain coater among them.

In the electroconductive polymer material of the second exemplary embodiment, the addition ratio of the electroconductive polymer to the compound represented by Formula (1) is preferably 1:100 to 100000:1 by mass ratio, and more preferably 1:30 to 10000:1 and further preferably 1:10 to 1000:1 in view of film forming property, electroconductivity and tackiness.

<Device>

Since the electroconductive film of the present invention is excellent in durability under humidity and heat, transparency and electroconductivity, it may be preferably used for wiring of electronic materials and electrodes (substrate electrodes and the like). Since the electroconductive film of the present invention may be formed by coating, it is easily prepared into an electrode material having a large area and suitable for application to substrate electrodes.

Furthermore, the electroconductive polymer material of the present invention having the electroconductive film of the present invention or a film formed from the electroconductive polymer composition of the present invention is excellent in durability under humidity and heat, transparency and electroconductivity.

Such electroconductive film may be preferably used for various devices such as a flexible electroluminescence device (OLED), touch panel, organic TFT, actuator, sensor, electronic paper, flexible dimming material and solar battery.

### EXAMPLES

The present invention is hereinafter described more specifically by referring to examples. Materials, reagents, amount of substances and ratio, and operations thereof described in the following examples may be properly modified unless deviating from the spirit of the present invention. Accordingly, the scope of the present invention is not limited to the following examples.

### Example 1

A polyethylene terephthalate (hereinafter referred to as PET) resin having inherent viscosity of 0.66, which was obtained by polycondensation using Ge as a catalyst, was dried so that its water content became 50 ppm or less. Heater temperature was adjusted to 280 to 300° C., and the resin was melted in an extruder. The melted PET resin was ejected from a die portion onto a chill roll on which static charge had been applied to give an amorphous base. The obtained amorphous base was stretched in the running direction of the base by 3.3-fold, and stretched in the width direction by 3.8-fold to give a PET substrate having a thickness of 188 μm.

Ethanol of the same mass was added to an aqueous dispersion liquid of poly(3,4-ethylenedioxy)thiophene (PEDOT)-polystyrene sulfonate (PSS) (trade name: BAYTRON P HC V4, manufactured by H.C. Starck) by the same mass and mixed to give the coating liquid-1.

This coating liquid-1 was applied on the above-mentioned PET substrate (transmittance: 91% (550 nm)) using a No. 9 bar coater, and dried on a hot plate at 120° C. to give the electroconductive coating film 1. The thickness of the electroconductive coating film 1 was measured by probe method and found to be 50 nm.

Ethylene glycol was applied on the electroconductive coating film 1 using a spin coater (500 rpm×5 sec, 3000 rpm×20 sec), and dried on a hot plate at 120° C.

A 1 mass % ethanol solution of the above-mentioned specific example compound (1) was prepared, and applied using a spin coater (500 rpm×5 sec, 3000 rpm×20 sec) on the electroconductive coating film 1 on which ethylene glycol had been applied. This was dried on a hot plate at 120° C. to give the sample-1. The film thickness of the sample-1 except the thickness of the PET substrate was 50 nm to 60 nm.

The sample-1 was evaluated by the following method.

<Measurement of Transmittance>

The transmittance of light at 550 nm was measured using an UV/vis spectrometer (trade name: Shimadzu U2400). The measurement was performed at the center part of the sample-1 immediately after preparation. The result is shown in Table 1.

<Measurement of Surface Resistance Value>

The surface resistance value was measured using a surface resistance measuring apparatus (trade name: LOWRESTER GP, manufactured by Mitsubishi Chemical Corporation). Nine portions in the samples immediately after preparation were measured according to JIS-K7194 specification, and the average value thereof was used as a measured value. The result is shown in Table 1.

### Example 2

The sample-2 was prepared in a similar manner to Example 1 except that the specific example compound (5) was added instead of the specific example compound (1). The specific example compound (5) was added so that it had the same mass as that of the specific example compound (1) that was added in Example 1. The obtained sample was evaluated in a similar manner to Example 1. The result of the evaluation is shown in Table 1.

### Example 3

The sample-3 was prepared in a similar manner to Example 1 except that the specific example compound (16) was added instead of the specific example compound (1). The specific example compound (16) was added so that it had the same mass as that of the specific example compound (1) that was added in Example 1. The obtained sample was evaluated in a similar manner to Example 1. The result of the evaluation is shown in Table 1.

### Example 4

The sample-4 was prepared in a similar manner to Example 1 except that the specific example compound (19) was added instead of the specific example compound (1). The specific example compound (19) was added so that it had the same mass as that of the specific example compound (1) that was added in Example 1. The obtained sample was evaluated in a similar manner to Example 1. The result of the evaluation is shown in Table 1.

### Example 5

The sample-5 was prepared in a similar manner to Example 1 except that the specific example compound (23) was added instead of the specific example compound (1). The specific example compound (23) was added so that it had the same mass as that of the specific example compound (1) that was added in Example 1. The obtained sample was evaluated in a similar manner to Example 1. The result of the evaluation is shown in Table 1.

### Comparative Example 1

The comparative sample-1 was prepared in a similar manner to Example 1 except that the solution of the specific example compound (1) was not applied. The obtained comparative sample-1 was evaluated in a similar manner to Example 1. The result of the evaluation is shown in Table 1.

### Comparative Example 2

The comparative sample-2 was prepared in a similar manner to Example 1 except that the specific example compound (1) in Example 1 was replaced with methyl gallate (described in JP-A No. 2006-131873). The obtained comparative sample-2 was evaluated in a similar manner to Example 1. Methyl gallate was added so that it had the same mass as that of the specific example compound (1) that was added in Example 1. The result of the evaluation is shown in Table 1.

### Comparative Example 3

The comparative sample-3 was prepared in a similar manner to Example 1 except that the specific example compound (1) in Example 1 was replaced with hydroquinone (described in JP-A No. 2006-131873). The obtained comparative sample-3 was evaluated in a similar manner to Example 1. Hydroquinone was added so that it had the same mass as that of the specific example compound (1) that was added in Example 1. The result of the evaluation is shown in Table 1.

TABLE 1

| | | Immediately after preparation | |
|---|---|---|---|
| | | Surface | |
| | | resistance | Transmittance |
| Sample | Additive | (Ω/□) | (%) |
| Example 1 | Compound (1) | 770 | 86 |
| Example 2 | Compound (5) | 740 | 86 |
| Example 3 | Compound (16) | 790 | 86 |
| Example 4 | Compound (19) | 780 | 86 |
| Example 5 | Compound (23) | 780 | 86 |
| Comparative Example 1 | None | 990 | 86 |
| Comparative Example 2 | Methyl gallate | 1020 | 84 |
| Comparative Example 3 | Hydroquinone | 1410 | 83 |

As shown in the results in Table 1, Examples 1 to 5 exhibited lower surface resistance values than that of Comparative Example 1 in which no additive was added. Furthermore, in Comparative Examples 2 and 3, the surface resistance value was higher and the transmittance was lower than those of Examples 1 to 5. It was apparent from the above-mentioned results that that the samples 1 to 5 in Examples 1 to 5 were excellent in electroconductivity and transparency.

### Example 6

An ethanol solution containing 10 mass % of ethylene glycol was added to an aqueous dispersion of poly(3,4-ethylenedioxy)thiophene (PEDOT)-polystyrenesulfonate (PSS) (trade name: Baytron PH500, manufactured by H. C. Starck) by the same mass and mixed to give the coating liquid-6.

This coating liquid-6 was applied on the PET substrate using a No. 9 bar coater, and dried on a hot plate at 120° C. to give the electroconductive coating film 6. The thickness of the obtained layer was 60 nm.

The above-mentioned specific example compound (5) was dissolved in a mixed solution of isopropanol:ethylene glycol=4:1 so as to became 0.2 mass % to give the solution-6.

The prepared solution-6 was applied on the electroconductive coating film 6 using a No. 3 bar coater, and dried on a hot plate at 120° C. to give the sample-6. The film thickness of the sample-6 except the thickness of the PET substrate was 60 nm to 65 nm. The sample-6 was evaluated as follows.

<Evaluation Durability Under Humidity and Heat>

Durability under humidity and heat testing was performed in a thermo-hygrostat apparatus (trade name: IG420, manufactured by Yamato Scientific Co., Ltd.) at the conditions of temperature of 60° C. and humidity of 90% RH. The transmittance and surface resistance value after passage of 500 hours were measured by the above-mentioned method. The results of evaluation were shown in Table 2.

### Example 7

The sample-7 was prepared in a similar manner to Example 6 except that the specific example compound (19) was added instead of the specific example compound (5). The specific example compound (19) was added so that it had the same mass as that of the specific example compound (5) that was added in Example 6. The obtained sample-7 was evaluated in a similar manner to Example 6. The result of the evaluation is shown in Table 2.

### Example 8

The sample-8 was prepared in a similar manner to Example 6 except that the specific example compound (23) was added instead of the specific example compound (5). The specific example compound (23) was added so that it had the same mass as that of the specific example compound (5) that was added in Example 6. The obtained sample-8 was evaluated in a similar manner to Example 6. The result of the evaluation is shown in Table 2.

### Example 9

The above-mentioned specific example compound (19) was dissolved in a mixed solution of isopropanol:ethylene glycol=4:1 so as to become 0.2 mass %, and hydroxamic acid was further dissolved so as to become 0.2 mass % to give the solution-9.

The solution-9 prepared as above was applied on the electroconductive coating film 6 obtained in Example 6 using a No. 3 bar coater, and dried on a hot plate at 120° C. to give the sample-9. The obtained sample-9 was evaluated in a similar manner to Example 6. The result of the evaluation is shown in Table 2.

### Example 10

The above-mentioned specific example compound (19) was dissolved in a mixed solution of isopropanol:ethylene glycol=4:1 so as to became 0.2 mass %, and a phosphite ester antioxidant (trade name: IRGAFOS12, manufactured by Ciba Specialty Chemicals, Inc.) was further dissolved so as to became 0.2 mass % to give the solution-10.

The solution-10 prepared as above was applied on the electroconductive coating film 6 obtained in Example 6 using a No. 3 bar coater, and dried on a hot plate at 120° C. to give the sample-10. The obtained sample-10 was evaluated in a similar manner to Example 6. The result of the evaluation is shown in Table 2.

### Example 11

Similarly to Example 1, ethanol was added to an aqueous dispersion liquid of poly(3,4-ethylenedioxy)thiophene (PEDOT)-polystyrenesulfonate (PSS) (trade name: Baytron P HC V4, manufactured by H.C. Starck) by the same mass and mixed to give the coating liquid-11. The coating liquid-11was applied on a PET film using a No. 9 bar coater to give the electroconductive coating film 11. The thickness of the obtained layer was 60 nm.

Meanwhile, an ethanol solution-11containing 1 mass % of the specific example compound (19) was prepared.

The electroconductive coating film 11 was dried on a hot plate at 120° C., and during the drying, 0.1 g of the ethanol solution-11 was uniformly sprayed on the surface. The drying was further performed at 120° C. to remove the solvent to give the sample-11. The total thickness of the sample-11 was 60 to 65 nm.

The result of the evaluation of the thus-obtained sample-11 is shown in Table 2.

### Comparative Example 4

The comparative sample-4 was prepared in a similar manner to Example 6 except that the solution of the specific example compound (5) was not added. The obtained comparative sample-4 was evaluated in a similar manner to Example 6. The result of the evaluation is shown in Table 2.

### Comparative Example 5

The comparative sample-5 was prepared in a similar manner to Example 6 except that the compound (5) in Example 6 was replaced with hydroquinone. The comparative sample-5 was evaluated in a similar manner to Example 6. The result of the evaluation is shown in Table 2.

### Comparative Example 6

The comparative sample-6 was prepared in a similar manner to Example 6 except that the compound (5) in Example 6 was replaced with the polyester described in the Examples of JP-A No. 2007-95506. The comparative sample-6 was evaluated in a similar manner to Example 6. The result of the evaluation is shown in Table 2.

### Comparative Example 7

The comparative sample-7 was prepared in a similar manner to Example 6 except that the compound (5) in Example 6 was replaced with a fluorine-based surfactant (trade name: F444, manufactured by DIC Corporation) (JP-A No. 2006-302561). The comparative sample-7 was evaluated in a similar manner to Example 6. The result of the evaluation is shown in Table 2.

### Comparative Example 8

The comparative sample-8 was prepared in a similar manner to Example 6 except that the compound (5) in Example 6 was replaced with a polyphosphoric acid (manufactured by Tokyo Chemical Industry Co., Ltd.) (Japanese National Phase PCT Laid-Open Publication No. 2006-505099). The comparative sample-8 was evaluated in a similar manner to Example 6. The result of the evaluation is shown in Table 2.

TABLE 2

| | | Before passage | | | |
|---|---|---|---|---|---|
| | | of time under | | After passage of time | |
| | | humidity and heat | | under humidity and heat | |
| | | Surface | | Surface | |
| | | resistance | Transmittance | resistance | Transmittance |
| Sample | Additive | (Ω/□) | (%) | (Ω/□) | (%) |
| Example 6 | Compound (5) | 450 | 88 | 550 | 87 |
| Example 7 | Compound (19) | 460 | 88 | 560 | 87 |
| Example 8 | Compound (23) | 480 | 87 | 600 | 87 |
| Example 9 | Compound (19), | 430 | 87 | 510 | 87 |
| | hydroxamic acid | | | | |
| Example 10 | Compound (19), | 420 | 87 | 530 | 87 |
| | phosphite ester | | | | |
| Example 11 | Compound (19) | 480 | 88 | 590 | 87 |
| Comparative | None | 480 | 88 | 780 | 87 |
| Example 4 | | | | | |
| Comparative | Hydroquinone | 750 | 85 | 920 | 84 |
| Example 5 | | | | | |
| Comparative | Polyester | 580 | 87 | 680 | 85 |
| Example 6 | | | | | |
| Comparative | F444 | 700 | 87 | 1120 | 87 |
| Example 7 | | | | | |
| Comparative | Polyphosphoric | 460 | 87 | 650 | 87 |
| Example 8 | acid | | | | |

As shown in the results in Table 2, the samples of Examples 6 to 11 exhibited high transmittance and low value of surface resistance before passage of time under humidity and heat. Furthermore, they maintained high transmittance and low value of surface resistance even after passage of time under humidity and heat. Therefore,the samples of Examples were excellent in durability against humidity and heat.

On the other hand, in Comparative Examples 4 and 8, the surface resistance value after passage of time under humidity and heat significantly increased as compared to those of Examples 6 to 11. In Comparative Examples 5 to 7, the surface resistance was high even before passage of time under humidity and heat, and the surface resistance tended to further increase after passage of time under humidity and heat.

<Evaluation of Light Resistance>

Light resistance was evaluated as follows for the samples prepared in Examples 6 to 11 and Comparative Examples 4 and 8.

The light resistance test was performed over time using a discoloration tester (xenon lamp, 170,000 lux, equipped with an infrared cut filter). The transmittance and surface resistance value after passage of 72 hours were measured by the above-mentioned method. The result of the evaluation is shown in Table 3.

### Comparative Example 9

The comparative sample-9 was prepared in a similar manner to Example 6 except that the compound (5) in Example 6 was replaced with a phosphite ester-based antioxidant (trade name: IRGAFOS12, manufactured by Ciba Specialty Chemicals). Light resistance was evaluated for this comparative sample-9 according to the above-mentioned method. The result of the evaluation is shown in Table 3.

TABLE 3

| | | Before irradiation | | | |
|---|---|---|---|---|---|
| | | of light | | After irradiation of light | |
| | | Surface | | Surface | |
| | | resistance | Transmittance | resistance | Transmittance |
| Sample | Additive | (Ω/□) | (%) | (Ω/□) | (%) |
| Example 6 | Compound (5) | 480 | 88 | 660 | 87 |
| Example 7 | Compound (19) | 440 | 88 | 620 | 87 |
| Example 8 | Compound (23) | 470 | 88 | 630 | 87 |
| Example 9 | Compound (19), | 400 | 88 | 540 | 87 |
| | hydroxamic acid | | | | |
| Example 10 | Compound (19), | 400 | 88 | 550 | 87 |
| | phosphite ester | | | | |
| Example 11 | Compound (19) | 450 | 88 | 650 | 87 |
| Comparative | None | 460 | 88 | 1200 | 87 |
| Example 4 | | | | | |
| Comparative | Polyphosphoric | 410 | 88 | 610 | 85 |
| Example 8 | acid | | | | |
| Comparative | Phosphite ester | 470 | 87 | 860 | 86 |
| Example 9 | | | | | |

As shown in the results in Table 3, the surface resistance values after irradiation of light for the samples of Examples 6 to 11 were maintained to be lower values than those of Comparative Examples 4, 8 and 9, and the transmittances after irradiation of light for the samples of Examples 6 to 11 were maintained to be higher values than those of Comparative Examples 8 and 9. Therefore, the samples of Examples were excellent in durability against light.

### Example 12

The solution-6 prepared in Example 6 was applied on a PET film using a No. 3 bar coater, and dried on a hot plate at 120° C. to give the coating film 12. The coating liquid-6 prepared in Example 6 was applied on the coating film 12 prepared as above using a No. 9 bar coater, and dried on a hot plate at 120° C. to give the sample-12. The durability under humidity and heat of the sample-12 was evaluated in a similar manner to Example 6. The result of the evaluation is shown in Table 4.

### Example 13

The solution-6 prepared in Example 6 was further applied on the sample-12 prepared in Example 12 using a No. 3 bar coater, and dried on a hot plate at 120° C. to give the sample-13. The durability under humidity and heat of the sample-13 was evaluated in a similar manner to Example 6. The result of the evaluation is shown in Table 4.

TABLE 4

| | | Before passage | | After passage | |
|---|---|---|---|---|---|
| | | of time under | | of time under | |
| | | humidity and heat | | humidity and heat | |
| | | Surface | Trans- | Surface | Trans- |
| | Additive | resistance | mittance | resistance | ittance |
| Sample | layer | (Ω/□) | (%) | (Ω/□) | (%) |
| Example 12 | Under | 470 | 88 | 660 | 87 |
| | coating | | | | |
| Example 13 | Under | 460 | 88 | 540 | 87 |
| | coating | | | | |
| | and top | | | | |
| | coating | | | | |
| Comparative | None | 480 | 88 | 780 | 87 |
| Example 4 | | | | | |

As shown in the results in Table 4, in the case where the additive layer was provided between the electroconductive film and the PET film (Example 12), the transmittance was higher and the value of surface resistance was maintained to be lower than those of Comparative Example 4 having no additive layer even after passage of time under humidity and heat. Therefore, durability under humidity and heat was excellent. Furthermore, it was found that the durability against humidity and heat was further improved where the additive layers were provided on both surfaces of the electroconductive film (Example 13).

### Example 14

(3,4-Ethylenedioxy)thiophene (EDOT), imidazole and iron(III) p-toluenesulfonate were mixed so that the mass ratio became 1:1:8, and a 60 mass % ethanol solution was prepared. The specific example compound (19) was added to the solution so as to became 1 mass % and mixed to give the coating liquid-14.

The coating liquid-14 was applied on a PET substrate using a spin coater (3000 rpm×20 seconds) and heated on a hot plate at 120° C. to polymerize EDOT. The substrate was allowed to cool, washed with ethanol, and dried again on the hot plate to give the sample-14.

The thus-obtained sample-14 was evaluated in a similar manner to Example 6. The result of the evaluation is shown in Table 5.

### Comparative Example 10

The comparative sample-10 was prepared in a similar manner to Example 14 except that the specific example compound (19) was not added in Example 14. The obtained comparative sample-10 was evaluated in a similar manner to Example 6. The result of the evaluation is shown in Table 5.

TABLE 5

| | Before passage of time under | | After passage of time under | |
|---|---|---|---|---|
| | humidity and heat | | humidity and heat | |
| | Surface | | Surface | |
| | resistance | Transmittance | resistance | Transmittance |
| Sample | (Ω/□) | (%) | (Ω/□) | (%) |
| Example 14 | 330 | 74 | 760 | 72 |
| Comparative | 340 | 74 | 1190 | 71 |
| Example 10 | | | | |

The foregoing description of the embodiments of the present invention has been provided for the purposes of illustration and description. It is not intended to be exhaustive or to limit the present invention to the precise forms disclosed. Obviously, many modifications and variations will be apparent to practitioners skilled in the art. The embodiments were chosen and described in order to best explain the principles of the present invention and its practical applications, thereby enabling others skilled in the art to understand the present invention for various embodiments and with the various modifications as are suited to the particular use contemplated. It is intended that the scope of the present invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. An electroconductive film comprising an electroconductive polymer and a compound represented by the following Formula (1): 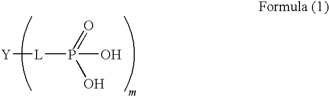
wherein Y is a hydrogen atom, a carbon atom, a hetero atom, a hydroxy group, a mercapto group, a group derived from an amino group, a group derived from an alkyl group, a group derived from an acyl group, a group derived from an aryl group, a group derived from an alkoxy group, a group derived from an aryloxy group, or a group derived from a heteroaryl group; L is a single bond, a divalent hydrocarbon group, a divalent hetero atom or an imino group; and m is an integer of 1 or more.

2. The electroconductive film according to claim 1, wherein the electroconductive polymer comprises polythiophene or a derivative thereof.

3. The electroconductive film according to claim 2, wherein the electroconductive polymer comprises poly(3,4-ethylenedioxy)thiophene.

4. The electroconductive film according to claim 1, further comprising polystyrene sulfonic acid as a dopant.

5. The electroconductive film according to claim 1, wherein the compound represented by Formula (1) is localized on the surface thereof.

6. The electroconductive film of claim 1, wherein the content ratio of the compound represented by Formula (1) to the electroconductive polymer (compound represented by Formula (1): electroconductive polymer) is in the range of from 0.0005:1.0 to 100:1 by mass ratio.

7. An electroconductive polymer composition comprising an electroconductive polymer or a precursor thereof and a compound represented by the following Formula (1): 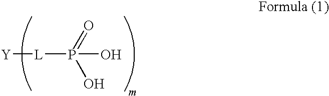
wherein Y is a hydrogen atom, a carbon atom, a hetero atom, a hydroxy group, a mercapto group, a group derived from an amino group, a group derived from an alkyl group, a group derived from an acyl group, a group derived from an aryl group, a group derived from an alkoxy group, a group derived from an aryloxy group, or a group derived from a heteroaryl group; L is a single bond, a divalent hydrocarbon group, a divalent hetero atom or an imino group; and m is an integer of 1 or more.

8. An electroconductive film, which is formed by using the electroconductive polymer composition according to claim 7.

9. An electroconductive polymer material comprising
a substrate, and
an electroconductive polymer layer containing an electroconductive polymer and a compound represented by the following Formula (1): 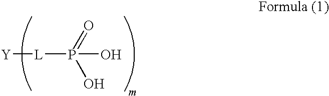
wherein Y is a hydrogen atom, a carbon atom, a hetero atom, a hydroxy group, a mercapto group, a group derived from an amino group, a group derived from an alkyl group, a group derived from an acyl group, a group derived from an aryl group, a group derived from an alkoxy group, a group derived from an aryloxy group, or a group derived from a heteroaryl group; L is a single bond, a divalent hydrocarbon group, a divalent hetero atom or an imino group; and m is an integer of 1 or more.

10. The electroconductive polymer material according to claim 9, wherein the electroconductive polymer layer is formed by using the electroconductive polymer composition comprising an electroconductive polymer or a precursor thereof and the compound represented by Formula (1).

11. An electroconductive polymer material comprising
a layer containing an electroconductive polymer, and
a layer containing a compound represented by the following Formula (1), which is formed on at least one surface of the layer containing an electroconductive polymer: 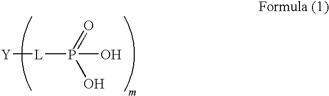
wherein Y is a hydrogen atom, a carbon atom, a hetero atom, a hydroxy group, a mercapto group, a group derived from an amino group, a group derived from an alkyl group, a group derived from an acyl group, a group derived from an aryl group, a group derived from an alkoxy group, a group derived from an aryloxy group, or a group derived from a heteroaryl group; L is a single bond, a divalent hydrocarbon group, a divalent hetero atom or an imino group; and m is an integer of 1 or more.

12. The electroconductive polymer material according to claim 11, wherein the layer containing the compound represented by Formula (1) is provided on both surfaces of the electroconductive polymer layer.

13. The electroconductive polymer material according to claim 9, wherein the electroconductive polymer material is transparent.

14. A device using the electroconductive film according to claim 1.

15. A device using the electroconductive film according to claim 8.

16. A device using the electroconductive polymer material according to claim 9.

17. A device using the electroconductive polymer material according to claim 11.
